(19) United States
(12) Patent Application Publication
(10) Pub. No.: US 2025/0126632 A1
(43) Pub. Date: Apr. 17, 2025

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Rongyi HU, Dongguan (CN); Jinyu ZHANG, Dongguan (CN)

(21) Appl. No.: 18/982,097

(22) Filed: Dec. 16, 2024

Related U.S. Application Data
(63) Continuation of application No. PCT/CN2022/112287, filed on Aug. 12, 2022.

(30) Foreign Application Priority Data
Aug. 10, 2022 (WO) PCT/CN2022/111580

(51) Int. Cl. H04W 72/51; H04B 7/06; H04L 27/26; H04W 72/0453

(52) U.S. Cl. CPC H04W 72/51; H04B 7/06968; H04L 27/26025; H04W 72/0453

(57) ABSTRACT

A wireless communication method and a terminal device are provided. The method includes following operations. A terminal device determines, in case that the terminal device has a first capability, that there is no measurement restriction and/or scheduling availability in a first scenario. The first capability at least indicates that the terminal device is capable of simultaneously receiving multiple channels and/or signals on multiple reception beams, and the first scenario is a scenario in which time-domain resources of multiple channels and/or signals to be received by the terminal device overlap.

### CROSS-REFERENCE TO RELATED APPLICATIONS

This application is a continuation application of International Patent Application No. PCT/CN2022/112287, filed on Aug. 12, 2022, which is filed based upon and claims priority to International Patent application No. PCT/CN2022/111580, filed on Aug. 10, 2022, and entitled “MEASUREMENT METHOD, CAPABILITY REPORT METHOD, MEASUREMENT CONFIGURATION METHODS, APPARATUSES AND DEVICE”, the entire disclosures of which are hereby incorporated by reference in their entireties.

### BACKGROUND

In a New Radio (NR) system, a scenario in which multiple Transmission/Reception Points (TRPs), multiple antennas (panels) or multiple beams simultaneously transmit downlink data to a terminal device exists. However, the current measurement requirements and scheduling requirements are formulated based on the reception of a signal on a single reception beam (Rx beam). There is currently no method yet about how to operate measurement restriction and/or scheduling availability after the terminal device has a capability of simultaneously receiving on multiple beams.

### SUMMARY

The embodiments of the disclosure relate to the technical field of mobile communications, and particularly to a wireless communication method and a terminal device.

A first aspect of the embodiments of the disclosure provides a wireless communication method, which includes the following operations.

A terminal device determines, in case that the terminal device has a first capability, that there is no measurement restriction and/or scheduling availability in a first scenario. The first capability at least indicates that the terminal device is capable of simultaneously receiving multiple channels and/or signals on multiple reception beams, and the first scenario is a scenario in which time-domain resources of multiple channels and/or signals to be received by the terminal device overlap.

A second aspect of the embodiments of the disclosure further provides a wireless communication method, which includes the following operations.

A network device determines, in case that a terminal device has a first capability, that the terminal device has no measurement restriction and/or scheduling availability in a first scenario. The first capability at least indicates that the terminal device is capable of simultaneously receiving multiple channels and/or signals on multiple reception beams, and the first scenario is a scenario in which time-domain resources of multiple channels and/or signals to be received by the terminal device overlap.

A third aspect of the embodiments of the disclosure provides a communication device, which may be the terminal device or the network device as described in the above solutions. The communication device includes a memory, a processor and a transceiver. The transceiver is configured to communicate with other devices. The memory is configured to store a computer program. The processor is configured to call the computer program from the memory and run the computer program, to perform the above wireless communication methods.

### BRIEF DESCRIPTION OF THE DRAWINGS

The drawings described herein are used for providing a further understanding of the disclosure and constitute a part of the disclosure. Exemplary embodiments of the disclosure and description thereof are used for illustrating the disclosure and not intended to constitute an improper limit to the disclosure. In the drawings:

FIG. 1 is a schematic diagram illustrating an application scenario according to an embodiment of the disclosure.

FIG. 2 is a first flowchart illustrating a wireless communication method according to an embodiment of the disclosure.

FIG. 3A is a first schematic diagram illustrating a multi-beam transmission according to an embodiment of the disclosure.

FIG. 3B is a second schematic diagram illustrating a multi-beam transmission according to an embodiment of the disclosure.

FIG. 4 is a schematic structural diagram of a communication processing chip according to an embodiment of the disclosure.

FIG. 5 is a second flowchart illustrating a wireless communication method according to an embodiment of the disclosure.

FIG. 6 is a third flowchart illustrating a wireless communication method according to an embodiment of the disclosure.

FIG. 7A is a first schematic diagram illustrating an optional reception direction according to an embodiment of the disclosure.

FIG. 7B is a second schematic diagram illustrating an optional reception direction according to an embodiment of the disclosure.

FIG. 7C is a third schematic diagram illustrating an optional reception direction according to an embodiment of the disclosure.

FIG. 8 is a first schematic structural diagram of a wireless communication device according to an embodiment of the disclosure.

FIG. 9 is a second schematic structural diagram of a wireless communication device according to an embodiment of the disclosure.

FIG. 10 is a schematic structural diagram of a communication device according to an embodiment of the disclosure.

FIG. 11 is a schematic structural diagram of a chip according to an embodiment of the disclosure.

FIG. 12 is a schematic block diagram of a communication system according to an embodiment of the disclosure.

### DETAILED DESCRIPTION

Technical solutions in the embodiments of the disclosure will be described below in combination with the drawings in the embodiments of the disclosure. It is apparent that the described embodiments are a part of the embodiments rather than all embodiments of the disclosure. All other embodiments obtained by those of ordinary skill in the art based on the embodiments in the disclosure without creative work shall fall within the scope of protection of the disclosure.

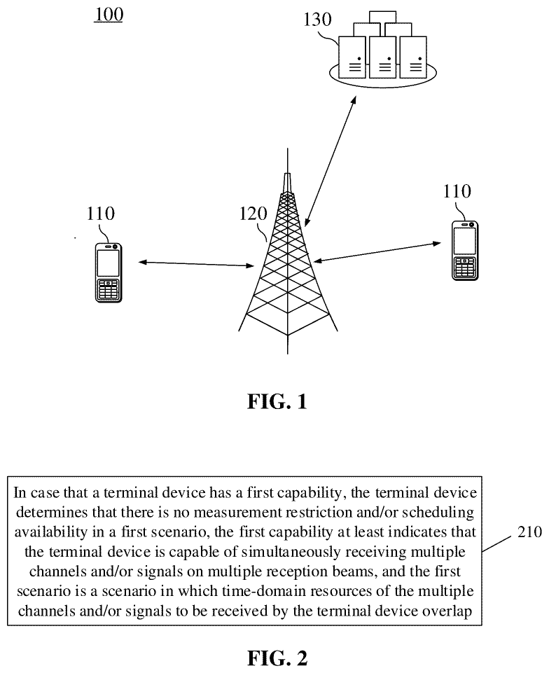

FIG. 1 is a schematic diagram illustrating an application scenario according to an embodiment of the disclosure.

As illustrated in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the disclosure are described only taking the communication system 100 as an example, but are not limited thereto. That is, the technical solutions of the embodiments of the disclosure may be applied to various communication systems, for example, a Long Term Evolution (LTE) system, an LTE Time Division Duplex (TDD) system, a Universal Mobile Telecommunication System (UMTS), an Internet of Things (IoT) system, a Narrow Band Internet of Things (NB-IoT) system, an enhanced Machine-Type Communication (eMTC) system, a 5th Generation (5G) communication system (also called a NR communication system), a future communication system and/or the like.

In the communication system 100 illustrated in FIG. 1, the network device 120 may be an access network device that communicates with the terminal device 110. The access network device may provide communication coverage for a specific geographical region and may communicate with the terminal device 110 (e.g., User Equipment (UE)) located in the coverage.

The network device 120 may be an Evolutional Node B (eNB or eNodeB) in a Long Term Evolution (LTE) system, or a Next Generation Radio Access Network (NG RAN) device, or a base station (gNB) in an NR system, or a wireless controller in a Cloud Radio Access Network (CRAN). Alternatively, the network device 120 may be a relay station, an access point, a vehicle-mounted device, a wearable device, a hub, a switch, a network bridge, a router, or a network device in a future evolutional Public Land Mobile Network (PLMN), etc.

The terminal device 110 may be any terminal device including, but not limited to, a terminal device wired or wirelessly connected to the network device 120 or other terminal devices.

For example, the terminal device 120 may be refer to an access terminal, a UE, a user unit, a user station, a mobile station, a remote station, a remote terminal, a mobile device, a user terminal, a terminal, a wireless communication device, a user agent or a user apparatus. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing devices connected to a wireless modem, a vehicle-mounted device, a wearable device, a terminal device in a 5G network or a terminal device in a future evolution network, or the like.

The terminal device 110 may be used for a Device to Device (D2D) communication.

The wireless communication system 100 may further include a core network device 130 that communicates with the network device 120. The core network device 130 may be a 5G Core (5GC) device, for example, an Access and Mobility Management Function (AMF), or an Authentication Server Function (AUSF), or a User Plane Function (UPF), or a Session Management Function (SMF). Optionally, the core network device 130 may also be an Evolved Packet Core (EPC) device in an LTE network, for example, a Session Management Function and Core Packet Gateway (SMF+PGW-C) device. It should be understood that the SMF+PGW-C can implement the functions that can be implemented by both the SMF and the PGW-C. In the process of network evolution, the core network device 130 may also be called by other names, or a new network entity may be formed by dividing the functions of the core network, which is not limited by the embodiments of the disclosure.

Connections may be established between various functional units of the communication system 100 through a next generation (NG) interface to realize communication.

For example, the terminal device establishes an air interface connection with the access network device through an NR interface, for transmitting data of the user plane and a signaling of the control plane. The terminal device may establish a signaling connection of a control plane with the AMF through an NG interface 1 (abbreviated as N1). The access network device, such as a next generation radio access base station (gNB), may establish a data connection of the user plane with the UPF through an NG interface 3 (abbreviated as N3). The access network device may establish a signaling connection of the control plane with the AMF through an NG interface 2 (abbreviated as N2). The UPF may establish a signaling connection of the control plane with the SMF through an NG interface 4 (abbreviated as N4). The UPF may interact data of the user plane with a data network through an NG interface 6 (abbreviated as N6). The AMF may establish a signaling connection of the control plane with the SMF through an NG interface 11 (abbreviated as N11). The SMF may establish a signaling connection of the control plane with a Policy Control Function (PCF) through an NG Interface 7 (abbreviated as N7).

FIG. 1 exemplarily illustrates one base station, one core network device, and two terminal devices. Optionally, the wireless communication system 100 may include multiple network devices and other number of terminal devices in the coverage of each network device, which is not limited by the embodiments of the disclosure.

It should be noted that the system to which the disclosure is applicable is shown in FIG. 1 as an example. The method illustrated in the embodiments of the disclosure may also be applicable to other systems. In addition, the terms “system” and “network” are usually used interchangeably herein. Herein, the term “and/or” merely indicates an association relationship that describes associated objects, and represents three relationships. For example, A and/or B may represent independent existence of A, existence of both A and B, and independent existence of B. In addition, the character “/” used herein usually represents that the associated objects before and after the character “/” form an “or” relationship. It should also be understood that “indication/indicate/indicating” mentioned in the embodiments of the disclosure may be a direct indication, an indirect indication, or an association relationship. For example, A indicates B, which may represent that A directly indicates B, e.g., B may be obtained from A; or may represent that A indirectly indicates B, e.g., A indicates C and B may be obtained from C; or may represent that there is an association relationship between A and B. It should also be understood that the “correspondence/correspond/corresponding” mentioned in the embodiments of the disclosure may represent that there is a direct correspondence or an indirect correspondence between two objects; or may represent an association relationship between the two objects, or a relationship between indication and being indicated, between configuration and being configured or the like. It should also be understood that the “predefinition/predefine” or “predefined rule” mentioned in the embodiments of the disclosure may be implemented by pre-storing corresponding codes or tables in devices (e.g., including terminal devices and network devices) or by other ways that may be used to indicate related information, and the specific implementation thereof is not limited herein. For example, the predefinition may refer to what is defined in the protocol. It should also be understood that in the embodiments of the disclosure, the “protocol” may refer to standard protocols in the communication field, including such as an LTE protocol, a NR protocol, and related protocols to be applied in a future communication system, which are not limited herein.

In order to facilitate understanding of the technical solutions in the embodiments of the disclosure, the related art of the embodiments of the disclosure will be described below. The following related art, as an optional solution, can be arbitrarily combined with the technical solutions in the embodiments of the disclosure, and all of them belong to the scope of protection of the embodiments of the disclosure.

In the evolution of communication technology, standard Release 15 (R15) only supports a single antenna panel or a single reception beam (Rx beam)/chain for receiving downlink signals/channels. R16 enhances a reception capability of the terminal device in a carrier aggregation scenario, and the terminal device can receive signals/channels on different carriers simultaneously using Independent Beam Management (IBM). In the IBM, the terminal device is required to have multiple baseband and radio frequency processing functions, and is able to use different Rx beams on different carriers to apply different panels to simultaneously receive multiple downlink signals/channels. Further, in an evolved Multiple-In-Multiple-Out (MIMO) technology, R16 introduces a capability of simultaneously using multiple Rx beams for reception on the same carrier, and the capability is usually indicated by a parameter “simultaneousReceptionDiffTypeD”. The parameter “simultaneousReceptionDiffTypeD” can be understood as simultaneously receiving two channels/signals of different Quasi Co-Location (QCL) types D. Since different QCL types D indicate different reception spatial information, which means that the terminal device requires multiple Rx beams simultaneously to receive two sets of channels/signals.

However, how to simultaneously use multiple Rx beams for reception on the same carrier is not clearly defined in the current protocol. Requirements of scheduling availability and measurement restriction should be clarified for simultaneous reception of channels/signals on a single carrier from different directions.

The scheduling availability/measurement restriction in the related art is described below.

First, scheduling availability/measurement restriction of Layer 1 (L1) is described below.

L1 is a physical layer, and a scenario of L1 measurement may include at least one of Radio Link Monitoring (RLM), Candidate Beam Detection (CBD), Beam Failure Detection (BFD), L1 Reference Signal Received Power (L1-RSRP) measurement, L1 Signal to Interference plus Noise Ratio (L1-SINR) measurement. The above measurement may be based on a Synchronization Signal/Physical Broadcast Channel Block (SS/PBCH Block, SSB), or may be based on a Channel State Information Reference Signal (CSI-RS) resource.

For a traditional Terrestrial Network (TN), time of the L1 measurement needs to meet the following conditions: 1) the L1 measurement should be kept outside the Measurement Gap (MG), 2) simultaneous measurements of L1 and Layer 3 (L3) are supported in a Frequency Range 1 (FR1) band, and 3) simultaneous measurements of L1 and L3 are not be supported in a Frequency Range 2 (FR2) band.

The scheduling availability of the L1 is described as follows.

The following scheduling availabilities may be applied for a RLM scenario of the FR2 (i.e., high frequency FR2 band). If a Transmission Configuration Indicator (TCI) state of currently active Physical Downlink Control Channel (PDCCH)/Physical Downlink Shared Channel (PDSCH) is QCL type D, and if the CSI-RS resource is repetitive, the scheduling availability is not required. Otherwise, the terminal device cannot transmit and receive data on a time-domain unit (e.g., an Orthogonal Frequency Division Multiplexing (OFDM) symbol) in which a reference signal for RLM measurement is located.

For a scenario in which intra-band carrier aggregation is performed in FR2, the scheduling availability applies to all serving cells on time-domain units in the same band that fully or partially overlap with restricted time-domain units (e.g., OFDM symbols).

For a scenario in which inter-band carrier aggregation is performed in FR2, if the terminal device can perform the IBM on the FR2 band, there is no scheduling availability on serving cell(s) in the FR2 in the following cases.

The RLM is performed on the FR2 band serving a Primary Cell (PCell) or a Primary Secondary Cell (PSCell) in different bands, and the terminal device is configured to have the same Sub-Carrier Spacing (SCS) or different sub-carrier spacings (typically characterized by the numerology) between an SSB on one FR2 band and data of the other FR2 band.

For FR2, if the terminal device has been notified about system information update through paging, or a gap between a PDCCH which is monitored by the terminal device in Type2-PDCCH Common Search Space (CSS) and notifies the system information update and a PDCCH which is monitored by the terminal device in Type0-PDCCH CSS is greater than 2 slots, the terminal device is expected to receive, on the time-domain unit of an SSB measured for the RLM, the PDCCH which is monitored by the terminal device in the Type0-PDCCH CSS and corresponding PDSCH for the SSB for the RLM and the control resource set (CORESET) for Remaining System Information (RMSI) scheduling multiplexing pattern 3; and the terminal device is expected to receive, on the time-domain unit of the SSB measured for the RLM, a PDSCH that the terminal device monitors in the Type0-PDCCH CSS set and a corresponding PDSCH, for the SSB for the RLM and the CORESET for RMSI scheduling multiplexing pattern 2.

The measurement restriction of the L1 is described below.

When a signal for RLM/BFD/CBD/L1-RSRP/L1-SINR measurement conflicts with other signals for the RLM/BFD/CBD/L1-RSRP/L1-SINR measurement on the same time-domain unit (for example, the OFDM symbol), the requirements of the measurement restriction includes the following cases.

First of all, SSB-based measurement restriction is introduced.

For band type 1 (i.e., low frequency FR1), when the SSB for the RLM/BFD/CBD/L1-RSRP/L1-SINR measurement conflicts with the CSI-RS for the RLM/BFD/CBD/L1-RSRP/L1-SINR measurement on the same time-domain unit (e.g., the OFDM symbol), the terminal device is able to perform measurement without any restriction if the SSB and the CSI-RS have the same SCS.

If the SSB and the CSI-RS have different SCSs, and the terminal device has a capability of simultaneously processing different numerology, and the capability is typically characterized by a parameter “simultaneousRxDataSSB-DiffNumerology”, the terminal device should be able to perform the measurement without any restriction. If the SSB and the CSI-RS have different SCSs, and the terminal device does not have the capability simultaneousRxDataSSB-DiffNumerology, the terminal device is restricted to measure one of the SSB and the CSI-RS, and cannot measure both simultaneously.

For FR2, when the SSB and the CSI-RS are in the same time-domain unit (e.g., the OFDM symbol) on the same Component Carrier (CC), or when the SSB and the CSI-RS are configured with different Numerology, and the SSB and the CSI-RS are on different FR2 bands and the terminal device does not have an IBM capability, the terminal device is restricted to measure one of the SSB and the CSI-RS and cannot measure both simultaneously.

CSI-RS-based measurement restriction is described as follows.

For both FR1 and FR2, when the CSI-RS for the RLM measurement and the SSB for the RLM/BFD/CBD/L1-RSRP measurement are in the same time-domain unit (e.g., the, the OFDM symbol), the terminal device does not need to receive the CSI-RS for the RLM measurement in a Physical Resource Block (PRB) overlapping with the SSB.

For FR2, when the CSI-RS for the RLM measurement on one CC is in the same time-domain unit (e.g., the OFDM symbol) as the SSB for the RLM/BFD/L1-RSRP measurement, or the BFD measurement or the L1-RSRP measurement are performed on the same CC or different CCs in the same band, or when beam failure is detected in the same domain unit (e.g., the OFDM symbol), the terminal device is required to measure one of the CSI-RS and the SSB, but cannot measure both simultaneously, for the SSB measured by the CBD on the same CC or different CCs on the same frequency band. The measurement based on the CSI-RS may have a longer measurement period and no requirements are defined.

For FR2, when a time-domain resource of a first CSI-RS for the L1-RSRP measurement and another time-domain resource of a second CSI-RS for the RLM, BFD, CBD, or L1-RSRP measurement are in the same time-domain unit (e.g., the OFDM symbol) on the same CC or different CCs in the same band, the terminal device is required to measure one of the first CSI-RS and the second CSI-RS, but cannot measure both simultaneously in following cases. The measurement based on the first CSI-RS or the second CSI-RS may have a longer measurement period.

The first CSI-RS resource or the second CSI-RS resource is configured as a repetitive resource.

The first CSI-RS and/or the second CSI-RS are configured in a beam detection numerology, and the beam failure of the first CSI-RS and/or the second CSI-RS are detected.

The type of QCL information associated with the first CSI-RS and the second CSI-RS is not the type D, or the QCL information of the first CSI-RS and the second CSI-RS is unknown information (i.e., the terminal device does not know the QCL information).

In addition to the above scenarios, the terminal device should be able to measure the first CSI-RS and the second CSI-RS without any restriction.

In summary, the measurement restriction of the L1 for the FR2 may be illustrated with reference to Table 1.

TABLE 1

| | SSB-based measurement | CSI-RS-based measurement |
|---|---|---|
| | restriction | restriction |
| RLM | If the SSB and the CSI-RS | For the same time-domain unit, |
| | are in the same band, only | it is not necessary to measure |
| | one of the SSB and the | the CSI-RS on the PRB |
| | CSI-RS is measured, and | overlapping with the SSB. |
| | the measurement period | If the CSI-RS and the SSB are |
| | can be extended; | in the same band, the terminal |
| | If the SSB and CSI-RS are | device only needs to measure |
| | in different bands and the | one of them. |
| | SSB and CSI-RS are | There is no scheduling |
| | configured with the same | availability for two CSI-RSs |
| | SCS or different SCSs, there | belonging to the same band |
| | is no restriction (assuming | except under specific |
| | that the terminal device | conditions. |
| | supports the IBM) | |
| BFD | The same as above | The same as above |
| CBD | The same as above | Different from the last item of |
| | | the RLM |
| L1-RSRP | The same as above | The same as the RLM |
| L1-SINR | The same as above | The same as the RLM |

Secondly, scheduling availability/measurement restriction of L3 are described below.

L3 measurement is mainly used for mobility management. The L3 measurement can be classified into SSB-based measurement and CSI-RS-based measurement based on the types of reference signals. The L3 measurement can be classified into same-frequency measurement and different-frequency measurement based on the frequency point/bandwidth configuration of the reference signals. The same-frequency SSB measurement as an example may be further classified into whether MG measurement is required based on the capability of the terminal device and SSB configuration information.

The SSB-based L3 measurement is mainly performed based on an SSB measurement timing configuration (SMTC) window, and measurement time will consider a cycle of the SMTC. The CSI-RS-based L3 measurement is temporarily not provided with a measurement window, and measurement time is directly calculated based on a cycle of the CSI-RS signal.

It should be understood that the RLM/BFD/CBD/L1-RSRP/L1-SINR measurement of the L1, the terminal device is required to complete the measurement outside the MG, and the signal to be measured is required in an active Bandwidth Part (BWP). In a current protocol, the L1 measurement is required to avoid the L3 measurement, that is, the MG or the measurement time window (e.g., SMTC) configured by the L3 measurement is avoided.

For L3 measurement using the MG, MG is reserved by default to facilitate the measurement. Hence there is no scheduling availability. However, L3 measurement without using the MG requires the scheduling availability.

Scheduling availability of the intra-frequency SSB without using the MG is described below. It should be noted that the scheduling availability is same as that of the intra-frequency SSB using Network Controlled Small Gap (NCSG).

Specifically, the following scheduling availability is applicable to the SS-RSRP measurement or SS-SINR measurement on the intra-frequency cell in the FR2.

Within the duration of the SMTC window, the terminal device is not expected to transmit a PUCCH/PUSCH/Sounding Reference Signal (SRS) or receive PDCCH/PDSCH/Tracking Reference Signal (TRS)/CSI-RS for a Channel Quality Indicator (CQI) on a time-domain unit (e.g. the OFDM symbol) of the SSB to be measured, and the above transmission or reception is on one time-domain unit before each SSB time-domain unit to be measured and on one time-domain unit after each SSB time-domain unit to be measured.

The following scheduling availability is applicable to SS-Reference Signal Received Quality (RSRQ) measurement on the intra-frequency cell in the FR2.

Within the duration of the SMTC window, the terminal device is not expected to transmit the PUCCH/PUSCH/SRS or receive the PDCCH/PDSCH/TRS/CSI-RS for the CQI on the time-domain unit of the SSB to be measured, the time-domain unit of Received Signal Strength Indication (RSSI) measurement, and one time-domain unit before each consecutive SSB to be measured, and one time-domain unit after each consecutive SSB to be measured.

Scheduling availability of the intra-frequency SSB using the MG is described below.

Specifically, the following scheduling availability is applicable to SS-RSRP measurement or SS-SINR measurement on the inter-frequency cell in the FR2.

Within the duration of the SMTC window, the terminal device is not expected to transmit the PUCCH/PUSCH/SRS or receive the PDCCH/PDSCH/TRS/CSI-RS for the CQI on the time-domain unit of the SSB to be measured, on one time-domain unit before the time-domain unit of each consecutive SSB to be measured, and on one time-domain unit after the time-domain unit of each consecutive SSB to be measured.

The scheduling availability is applicable to SS-RSRQ measurement on the intre-frequency cell in the FR2.

Within the duration of the SMTC window, the terminal device is not expect to transmit PUCCH/PUSCH/SRS or receive PDCCH/PDSCH/TRS/CSI-RS for the CQI on the time-domain unit of the SSB to be measured, the time-domain unit of the RSSI measurement, and one time-domain unit before each consecutive SSB to be measured and one time-domain unit after each consecutive SSB to be measured.

Scheduling availability of inter-frequency CSI-RS without using the MG is described below.

The terminal device is capable of measuring without the MG when the resources of the CSI-RS are fully contained in the active BWP of the terminal device. It should be noted that configured CSI-RS time-domain unit is indicated in firstOFDMSymbolInTimeDomain contained in the CSI-RS-ResourceConfigMobility for Radio Resource Management (RRM). When the terminal device is required to perform CSI-RS-based RRM measurement, there is scheduling availability in case that any of the following conditions is met; otherwise, there is no scheduling availability.

Scheduling availability of CSI-RS-based measurement is performed in a TDD band. When the terminal device performs CSI-RS intra-frequency measurement in the TDD band, the terminal device is not expected to transmit the PUCCH/PUSCH/SRS on a time-domain unit of a configured CSI-RS resource, and on one time-domain unit before each consecutively configured CSI-RS time-domain unit, and on one time-domain unit after each consecutively configured CSI-RS time-domain unit. The scheduling availability caused by a given serving cell is also applicable to all other serving cells in the same band on time-domain units that overlap fully or partially with the restricted time-domain units described above when TDD intra-band carrier aggregation is performed.

Scheduling availability of CSI-RS-based measurement is performed in the FR2. When the terminal device performs CSI-RS-based intra-frequency measurement for L3 mobility management in the FR2, the terminal device is not expected to transmit the PUCCH/PUSCH/SRS or receive the PDCCH/PDSCH/TRS/CSI-RS for the CQI on the time-domain unit of the CSI-RS in the configured slot, as indicated in the slot configuration of the corresponding CSI-RS resource to be measured for mobility.

The scheduling availability caused by a given serving cell is also applicable to all other serving cells in the same band on the time-domain units that overlap fully or partially with the restricted time-domain units described above when intra-band carrier aggregation is performed in the FR2.

Further, when inter-band carrier aggregation is performed in the FR2, there is no scheduling availability on FR2 serving cells in the band since CSI-RSRP measurement, CSI-RSRQ measurement or CSI-SINR measurement is performed on the FR2 intra-frequency cell in different bands, provided that the terminal device is capable of performing independent beam management for the FR2 band.

It can be seen that the L1/L3 measurement requirements and scheduling requirements in the existing protocols are formulated in receiving a signal using a single Rx beam. However, after the capability of receiving by multiple beams is introduced, scenarios that were limited by the measurement or the scheduling may also be reconsidered due to the capability that the terminal device can simultaneous receives on multiple beams in the FR2 changes. For example, a mechanism that the terminal device receives beam scanning during a measurement process changes, whether processing capabilities of the RF/antenna panel and the baseband are decoupled, whether multiple beams are merely an enhancement of antenna or RF capabilities, and whether corresponding baseband capabilities have also been enhanced.

The disclosure can address the above problems from the perspective of different capabilities or implementations supported by the terminal device, and improve the requirements of the scheduling availability or the measurement restriction for the terminal device during the measurement.

In order to facilitate understanding of the technical solutions in the embodiments of the disclosure, the technical solutions in the disclosure are described in detail below with reference to specific embodiments. The above related art as an optional solution may be arbitrarily combined with the technical solutions in the embodiments of the disclosure, and all of them belong to the scope of protection of the embodiments of the disclosure. The embodiments of the disclosure include at least part of the following contents.

As illustrated in FIG. 2, a wireless communication method provided by an embodiment of the disclosure includes the following operations.

At operation S210, a terminal device determines, in case that the terminal device has a first capability, that there is no measurement restriction and/or scheduling availability in a first scenario. The first capability at least indicates that the terminal device is capable of simultaneously receiving multiple channels and/or signals on multiple reception beams, and the first scenario is a scenario in which time-domain resources of multiple channels and/or signals to be received by the terminal device overlap.

It should be understood that the terminal device having the first capability may simultaneously receive multiple channels and/or signals in different directions through multiple reception beams. Herein, the number of multiple reception beams may be two or more, and different reception beams correspond to different directions.

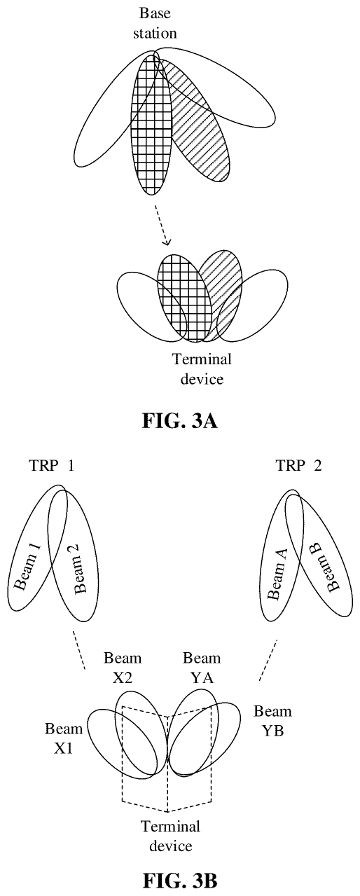

Illustratively, as illustrated in FIG. 3A and FIG. 3B, the terminal device may be provided with four reception beams, and the four reception beams may simultaneously receive up to four channels and/or signals (e.g., four channels, or four signals, or two channels and two signals, etc.). As illustrated in FIG. 3A, the terminal device may simultaneously receive multiple channels and/or signals from a cell. Specifically, multiple channels and/or signals may be transmitted by a base station in the cell through different beams, and multiple channels and/or signals may also be transmitted by beams at different Transmission/reception Points (TRPs) in the cell, which is not limited by the embodiments of the disclosures. As illustrated in FIG. 3B, the terminal device may simultaneously receive multiple channels and/or signals from different cells or different TRPs.

Optionally, the signal mentioned in the embodiment of the disclosure may be a reference signal for measurement, such as an SSB, a CSI-RS, a Positioning Reference Signal (PRS) and/or the like, which is not be limited by the embodiment of the disclosure.

Optionally, the channel mentioned in the embodiment of the disclosure may include a PDSCH, a PDCCH, and other downlink channels, which is not be limited by the embodiment of the disclosure.

It should be understood that measurement and scheduling in the related protocols are formulated based on receiving a signal on a single Rx beam, and the measurement and scheduling in some scenarios is restricted greatly. For example, in the scenario in which the time-domain resources of multiple channels and/or signals to be received by the terminal device overlap, the terminal device can only receive one of multiple channels and/or signals under certain conditions, and the terminal device needs to traverse all Rx beams to obtain a final measurement result. In an embodiment of the disclosure, the terminal device can determine that there is no measurement restriction and/or scheduling availability in certain scenarios when the terminal device has the capability of simultaneously receiving channels/signals on multiple beams. That is, the terminal device can eliminate original measurement restriction and/or scheduling availability based on the capability of simultaneously receiving multiple beams. In this way, the terminal device can reduce measurement time and data transmission time, thereby improving measurement efficiency and data transmission efficiency.

Accordingly, on a network side, a network device may also determine, in case that a terminal device has a first capability, that the terminal device has no measurement restriction and/or scheduling availability in a first scenario. In this way, the network device may simultaneously transmit multiple signals and/or channels to the terminal device through transmission beams in different directions. In this way, the time of the measurement based on the signal of the terminal device and the data transmission time are reduced, thereby improving the measurement efficiency and the data transmission efficiency.

Optionally, the first capability may include at least one of: a capability of simultaneously receiving multiple reference signals of different types on multiple reception beams; a capability of simultaneously receiving multiple reference signals for different purposes on multiple reception beams; a capability of simultaneously receiving multiple reference signals having different configurations on multiple reception beams; a capability of simultaneously receiving at least one reference signal and at least one channel on multiple reception beams; a capability of processing multiple channels and/or signals respectively through multiple baseband processing units; or a capability of receiving multiple channels and/or signals respectively through multiple Radio Frequency (RF) chains.

Optionally, multiple the reference signals of different types include at least two of an SSB, a CSI-RS or a PRS. Illustratively, if the terminal device is provided with two antenna panels corresponding to two reception beams in different directions, the first capability may include a capability of simultaneously receiving the SSB and the CSI-RS on the two reception beams, a capability of simultaneously receiving the SSB and the PRS on two reception beams, or a capability of simultaneously receiving the CSI-RS and the PRS on two reception beams. In addition, if the terminal device is provided with three antenna panels corresponding to three reception beams in different directions, the first capability may include a capability of simultaneously receiving the SSB, the CSI-RS and the PRS on the three reception beams, the first capability may also include a capability of simultaneously receiving one SSB and two different CSI-RSs on the three reception beams, and the first capability may also include a capability of combining other reference signals, which are not enumerated here.

Optionally, multiple reference signals for the different purposes include at least two of an SSB for RLM, an SSB for CBD, an SSB for BFD, an SSB for L1-RSRP measurement, an SSB for L1-SINR measurement, an SSB for L3 measurement, a CSI-RS for the RLM, a CSI-RS for the CBD, a CSI-RS for the BFD, a CSI-RS for the L1-RSRP measurement, a CSI-RS for the L1-SINR measurement, a CSI-RS for CQI, a CSI-RS for the L3 measurement, a PRS for RSRP measurement, a PRS for Reference Signal Time Difference (RSTD) measurement; or a PRS for measurement for a time difference (Rx-Tx time difference, RTT) between reception and transmission of the terminal device.

It should be understood that the first capability may include a capability of simultaneously receiving multiple reference signals of the same type but different purposes on multiple reception beams. Illustratively, if the terminal device is provided with two antenna panels respectively corresponding to two reception beams in different directions, the first capability may include a capability of simultaneously receiving the CSI-RS for the RLM and the CSI-RS for the CBD on the two reception beams, or other combinations of the same type but different purposes, which are not enumerated here.

In addition, the first capability may also include a capability of simultaneously receiving multiple reference signals of different types and different purposes on multiple reception beams. Illustratively, if the terminal device is provided with two antenna panels respectively corresponding to two reception beams in different directions, the first capability may include a capability of simultaneously receiving the SSB for the RLM and the CSI-RS for the CBD on the two reception beams, or other combinations of different types and different purposes, which are not enumerated here.

It should be noted that, in case that the terminal device does not explicitly indicate the purpose of the reference signal, the reference signal may be used for any purpose.

Optionally, configuration of the reference signal includes at least one of an SCS, a Resource Block (RB), a bandwidth or a resource type.

It should be understood that the first capability may include a capability of simultaneously receiving multiple reference signals of the same type but different configurations on multiple reception beams. Illustratively, the first capability may include a capability of receiving multiple CSI-RSs/CSI-RSs/PRSs having different SCSs on multiple reception beams, or the first capability may include a capability of simultaneously receiving multiple SSBs/CSI-RSs/PRSs having different numbers of RBs on multiple reception beams, or the first capability may include a capability of simultaneously receiving multiple SSBs/CSI-RSs/PRSs having different SCSs and different numbers of the RBs on multiple reception beams, which is not limited by the embodiments of the disclosure.

The first capability may also include a capability of simultaneously receiving multiple reference signals of different types and different configurations on multiple reception beams. Illustratively, the first capability may include a capability of receiving the CSI-RS and the SSB which have different SCSs on multiple reception beams. The first capability may further include a capability of simultaneously receiving multiple reference signals of the same type but different purposes and different configurations, on multiple reception beams, which is not limited by the embodiments of the disclosure.

It should be noted that the capability of simultaneously receiving at least one reference signal and at least one channel on multiple reception beams may include: simultaneously receiving at least one reference signal and at least one signal having the same configuration (e.g., the same SCS, PB, or bandwidth, etc.) on multiple reception beams, or simultaneously receiving at least one reference signal and at least one signal having different configurations (e.g. different SCSs, PBs, bandwidths, etc.) on multiple reception beams.

Optionally, the first capability may also include an enhanced baseband processing capability of the terminal device and/or an enhanced RF capability. Herein, the enhanced baseband processing capability of the terminal device means that the terminal device has multiple independent baseband processing units, and the terminal device can process multiple received channels and/or signals respectively (which can also be understood as simultaneously) through multiple baseband processing units. The enhanced RF capability may mean that the terminal device has multiple independent RF chains through which the terminal device may receive multiple channels and/or signals, respectively.

Illustratively, FIG. 4 is a schematic structural diagram of a processing chip, which may include a RF modem, a beamforming RF chip, a baseband processing chip and a battery management chip. It should be understood that, for the enhanced baseband processing capability of the terminal device, the baseband processing chip may include multiple independent processing units (cores), which may independently process different channels and/or signals. For the enhanced RF capability, the chip may include two RF chains (IF1 and IF2), through which the terminal device may receive multiple channels and/or signals, respectively.

Optionally, the enhanced baseband processing capability of the terminal device may be indicated by a parameter “independentBaseChain”. A normal baseband processing capability of the device may be indicated by a parameter “commonBaseChain”.

It should be understood that no measurement restriction and/or scheduling availability is applied when the terminal device has the enhanced baseband processing capability of the terminal device.

Optionally, the embodiment of the disclosure may extend and enhance a parameter “simultaneousReceptionDiffTypeD” in the existing protocol, and indicate different capabilities by the enhanced parameter “simultaneousReceptionDiffTypeD”.

It should be understood that the parameter “simultaneousReceptionDiffTypeD” indicates that the terminal device may simultaneously receive channels and/or signals associated with QCL information of two different QCL type D. Different QCL type D indicate different reception spatial information, that is, the terminal device can simultaneously receive two channels and/or signals using multiple Rx beams. It should be noted that the parameter “simultaneousReceptionDiffTypeD” in the existing protocol indicates the capability of simultaneous transmission of two TRPs having the same parameter configuration, and the reference configuration may include the SCS, SSB+SSB, CSI-RS+CSI-RS/data, SSB+CSI-RS, active BWP, and the like.

Illustratively, the terminal device may indicate using an enhanced parameter “simultaneousReceptionDiffTypeD_mixRS” that the terminal device has the capability of simultaneously receiving multiple reference signals of different types on multiple reception beams. If SCSs of multiple reference signals of different types are different, and the SCSs may be indicated by a numerology set “Numerology”, the terminal device may further indicate using both the parameter “simultaneousReceptionDiffTypeD_mixRS” and the parameter “simultaneousRxDataSSB-DiffNumerology” that the terminal device has the capability of simultaneously receiving multiple reference signals of different types having different SCSs on multiple reception beams in different directions.

Illustratively, the terminal device may indicate using an enhanced parameter “simultaneousReceptionDiffTypeD_CSIandCSI” that the terminal device has the capability of simultaneously receiving two or more CSI-RS resources on multiple reception beams. In case that SCSs of multiple CSI-RS resources are different, the terminal device may jointly indicate in conjunction with the parameter “simultaneousReceptionDiffTypeD_CSIandCSI” and the other parameter “simultaneousRxDataSSB-DiffNumerology” that the terminal device has the capability of simultaneously receiving multiple CSI-RSs having different SCSs on multiple reception beams in different directions.

Illustratively, the terminal device may indicate using a parameter “simultaneousReceptionDiffTypeD_CSIforBMandCQI” that the terminal device has the capability of simultaneously receiving multiple CSI-RSs having different purposes on multiple reception beams. The “BM” in the above parameter denotes beam management, which may include two purposes of the CBD and the FBD. Further, in case that SCSs of multiple CSI-RSs having different purposes are different, the terminal device may jointly indicate in conjunction with the parameter “simultaneousReceptionDiffTypeD_CSIforBMandCQI” and another parameter “simultaneousRxDataSSB-DiffNumerology” that the terminal device has the capability of simultaneously receiving the CSI-RS for the BM and the CSI-RS for CQI having different SCSs on multiple reception beams.

Illustratively, the terminal device may indicate using a parameter “simultaneousReceptionDiffTypeD_mixRSandData” that the terminal device has the capability of simultaneously receiving the reference signal and the conventional downlink channel on multiple reception beams. In addition, the capability of simultaneously receiving the reference signal and the conventional downlink channel on multiple reception beams may be further distinguished based on a reference signal and a downlink data, for example, using a parameter “simultaneousReceptionDiffTypeD_mixSSBandPDCCH” and a parameter “simultaneousReceptionDiffTypeD_mixSSBandPDSCH”. Similarly, the terminal device may further indicate in conjunction with the parameter “simultaneousRxDataSSB-DiffNumerology” that the terminal device has the capability of simultaneously receiving the reference signal and the downlink channel having different SCSs through different reception beams.

It should be understood that, in addition to indicating in conjunction with the two different parameters described above that the terminal device has the capability of simultaneously receiving channels and/or signals having different SCSs through multiple reception beams, a new parameter may further be defined for a direct indication. For example, the terminal device may indicate using only one parameter “simultaneousRxSSBdata-DiffSCS&diffTypeD” that the terminal device has the capability of simultaneously receiving reference signals and downlink channels having different SCSs through different reception beams. The embodiments of the disclosure do not limit the above-described indication patterns.

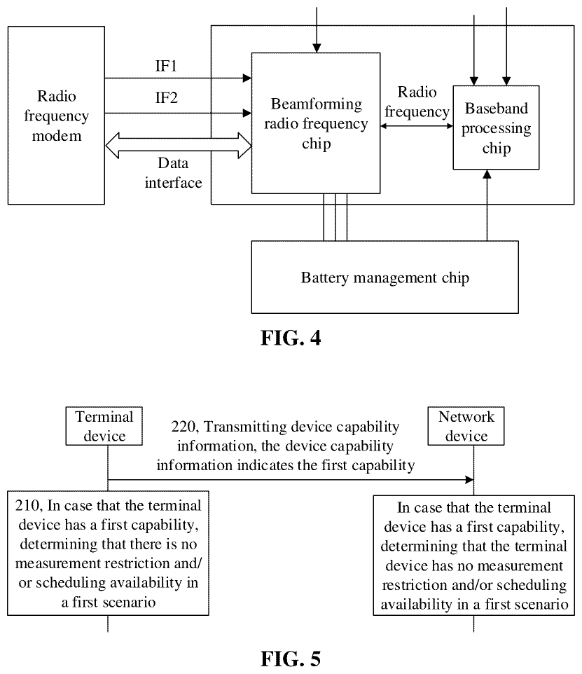

Optionally, as illustrated in FIG. 5, a wireless communication method provided by an embodiment of the disclosure may further include the following operations.

At operation 220, the terminal device transmits device capability information to the network device, and the device capability information indicates the first capability.

It can be understood that the terminal device may report its capability to the network device, so that the network device determines whether the terminal device eliminates the measurement restriction and/or scheduling availability in the first scenario through the first capability.

It should be noted that operation 220 may be executed before operation 210, or after operation 210, or simultaneously with operation 210, which is not limited by the embodiments of the disclosure.

Optionally, the device capability information may be reported to the network device by Radio Resource Control (RRC) signaling or Medium Access Control (MAC) signaling. The embodiments of the disclosure do not limit the reporting method.

Optionally, an object having the first capability in the embodiment of the disclosure may include at least one of the terminal device, a band, or a band combination.

It should be understood that the first capability may be a capability of the terminal device. That is, if the terminal device indicates the first capability through the device capability information, the terminal device can have the first capability in each band, thereby reducing signaling overhead for reporting the terminal capability.

The first capability may be used for the band combination, that is, the first capability may be a capability per band pair. The first capabilities of different band combinations may be reported independently. Illustratively, the first capability may be a capability of simultaneously receiving multiple channels and/or signals on a specific band pair through multiple reception beams. It should be understood that independent reporting of different band combinations improves the flexibility to a certain extent in the implementation of the terminal device.

The first capability may also be used for the band, that is, the first capability may be a capability per band. The first capabilities of different bands may be reported independently. Illustratively, the first capability may be a capability of simultaneously receiving multiple channels and/or signals on a specific carrier through multiple reception beams. It should be understood that independent reporting of different bands can provide the greater flexibility in the implementation of the terminal device.

Optionally, as illustrated in FIG. 6, a wireless communication method provided by an embodiment of the disclosure may further include the following operations.

At operation 230, the terminal device transmits first indication information to the network device. The first indication information indicates at least one of: the maximum number of the multiple reception beams; the multiple reception beams capable of simultaneous measurement; the multiple reception beams being capable of simultaneous measurement and channel reception; the number of reception beams capable of measurement among the multiple reception beams; the number of reception beams capable of L1 measurement among the multiple reception beams; the number of reception beams capable of L3 measurement among the multiple reception beams; or the number of reception beams of capable of the channel reception among the multiple reception beams.

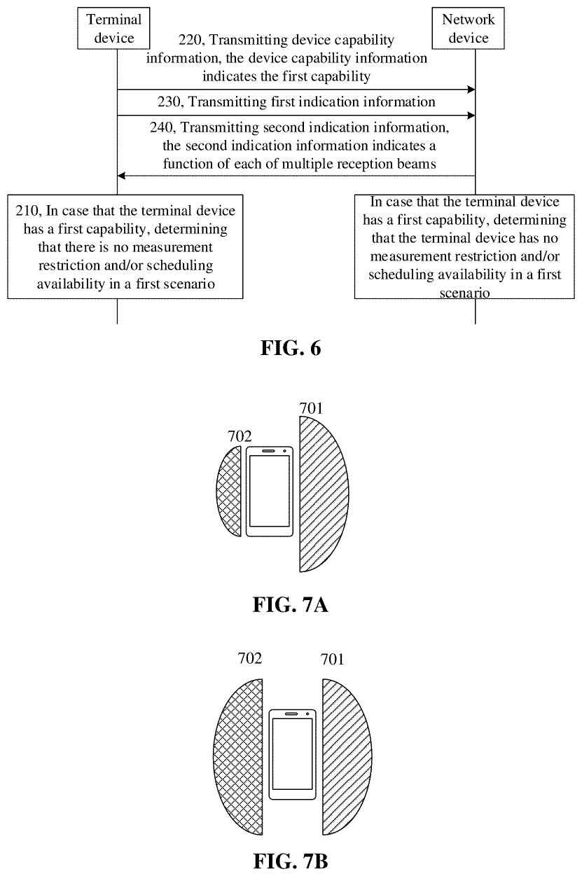

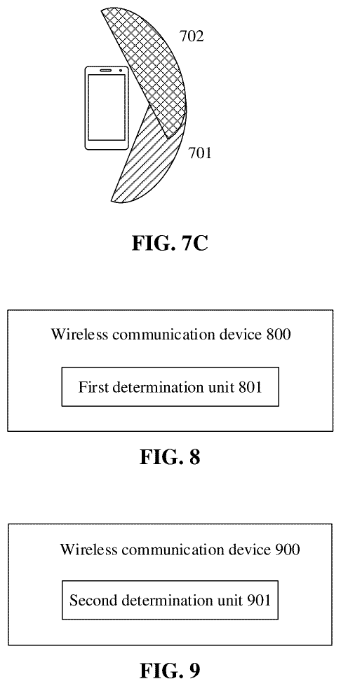

It should be understood that the terminal device may report to the network device the maximum number of Rx beams that can be received simultaneously. Herein different reception beams can be realized through different antennas, and different antennas have different spatial coverage and different Angle-of-Arrival (AOA). As illustrated in FIGS. 7A-7C, the spatial coverage 701 and the spatial coverage 702 are implemented based on different antennas and correspond to different AOAs. A relationship between the spatial coverage 701 and the spatial coverage 702 may include: different sizes and non-overlapping as illustrated in FIG. 7A, the same size and non-overlapping as illustrated in FIG. 7B, and the same size and overlapping as illustrated in FIG. 7C.

Optionally, the terminal device may indicate through a parameter “MaxnumSimReceptionDiffTypeD”. Illustratively, Nsim_Rx_beam={1, 2, 3, 4}.

It should be noted that the number of beams corresponding to each of multiple channels and/or signals to be received is less than or equal to the maximum number of multiple reception beams at operation 210. That is, the actual number of transmission beams of the network device is smaller than the maximum number of Rx beams used for simultaneous reception of the terminal device. In this way, different antennas of the terminal device may correspond to different transmission beams of the network device, thereby ensuring that the terminal device can simultaneously receive multiple channels and/or signals.

Optionally, the terminal device may further indicate to the network device, through the second indication information, a function which is desirable to be or can be implemented by Rx beams for simultaneous reception.

Illustratively, the terminal device may report, through a signaling parameter “SimL1AndL3MeasDiffTypeD”, that multiple Rx beams are desirable to be/can be used for simultaneous L1 and L3 measurements. The terminal device may report, through a signaling parameter “SimMeasAndDataDiffTypeD”, that multiple Rx beams are desirable to be/can be used for simultaneous measurement and downlink channel/signal reception.

Optionally, the terminal device may further report the number of Rx beams implementing each function through second indication information.

Illustratively, the terminal device may report the number of Rx beams desirable to be/can be used for the L3 measurement through a signaling parameter “numSimL3MeasDiffTypeD”, report the number of Rx beams desirable to be/can be used for the L1 measurement through a parameter “numSimL1MeasDiffTypeD”, and report the number of Rx beams are desirable to be/can be used for the channel reception through a parameter “numSimDataDiffTypeD”.

Optionally, the first indication information may be reported to the network device by the RRC signaling or the MAC signaling, and a reporting manner is not limited in the embodiments of the disclosure.

It should be noted that the first indication information and the device capability information may be transmitted in the same signaling or may be transmitted in different signaling, which is not limited by the embodiments of the disclosure.

Optionally, as illustrated in FIG. 6, a wireless communication method provided by an embodiment of the disclosure may further include the following contents.

At operation 240, the network device transmits second indication information to the terminal device, and the second indication information indicates a function of each of multiple reception beams.

It should be understood that the network device may specify the function of each reception beam based on the actual demand. That is, the network device may indicate through the second indication information that which beams among multiple reception beams configured by the terminal device are used to receive the reference signal, and which beams are used to receive the channels. Illustratively, the terminal device may specify functions to different reception beams based on directions and angles of the reception beams.

Optionally, the network device may determine the function of each reception beam based on the device capability information and/or the first indication information reported by the terminal device. Illustratively, the network device may set the function of each reception beam based on the types and the numbers of multiple channels and/or signals to be transmitted, as well as the number of reception beams used for L1 measurement indicated in the first indication information. Illustratively, the network device may determine whether the carriers for the multiple channels and/or signals to be transmitted are the same carrier or other scenarios, and determine the function of each reception beam based on the scenario as well as the device capability information and/or the first indication information reported by the terminal device, thereby avoiding the problem of measurement restriction and/or scheduling availability, and improving measurement efficiency and data transmission efficiency.

In an embodiment of the disclosure, the terminal device and/or the network device may determine that the terminal device has no measurement restriction and/or scheduling availability in the first scenario based on the specific content of the first capability.

Optionally, the terminal device and/or the network device determines that there is no measurement restriction in the first scenario in case that the first capability includes at least one of: a capability of simultaneously receiving multiple reference signals of different types on multiple reception beams; a capability of simultaneously receiving multiple reference signals for different purposes on multiple reception beams; a capability of simultaneously receiving multiple reference signals having different configurations on multiple reception beams; a capability of processing multiple signals respectively through multiple baseband processing units; or a capability of receiving multiple channels and/or signals respectively through multiple radio frequency chains.

Illustratively, when the time-domain resources of the SSB and the CSI-RS to be transmitted overlap (partially overlap or fully overlap), and the frequency-domain resources of the SSB and the CSI-RS to be transmitted belong to the same band, the terminal device may determine that there is no measurement restriction and measure the SSB and the CSI-RS simultaneously if the first capability includes the capability of simultaneously receiving multiple reference signals of different types on multiple reception beams and the capability may be indicated by the parameter “simultaneousReceptionDiffTypeD_mixRS”.

When the time-domain resources of the SSB and the CSI-RS to be transmitted overlap (partially overlap or fully overlap), and the SSB and the CSI-RS to be transmitted have different SCSs, the terminal device may determine that there is no measurement restriction and measure the SSB and the CSI-RS simultaneously if the first capability includes the capability of simultaneously receiving multiple reference signals of different types having different SCSs on multiple reception beams. Herein, the capability of simultaneously receiving multiple reference signals having different SCSs and different types on multiple reception beams may be indicated through both the parameter “simultaneousReceptionDiffTypeD_mixRS” and the parameter “simultaneousRx-DiffNumerology&diffTypeD”, or through an enhanced signaling parameter “simultaneousRxmixRS-DiffSCS&diffTypeD”, which is not limited by the embodiments of the disclosure.

Optionally, the terminal device determines that there is no scheduling availability in the first scenario in case that the first capability includes at least one of: a capability of simultaneously receiving multiple reference signals of different types on multiple reception beams; or a capability of simultaneously receiving at least one reference signal and at least one channel on multiple reception beams.

Illustratively, when the time-domain resources of the SSB and the PDSCH to be transmitted overlap (partially overlap or fully overlap), and the frequency-domain resources of the SSB and the PDSCH to be transmitted belong to the same band or different bands (the terminal device does not have the IBM capability in different bands), the terminal device determines that there is no scheduling availability if the first capability includes the capability of simultaneously receiving multiple reference signals of different types having different SCSs on multiple reception beams. The terminal device determines that the reception or transmission of the PDSCH cannot be performed on a conflicting time-domain unit, K time-domain units before the conflicting time-domain unit, and on K time-domain units after the conflicting time-domain unit when the first capability does includes the capability of simultaneously receiving multiple reference signals of different types having different SCSs on multiple reception beams. Among them, the above capability may be indicated by the enhanced parameter “simultaneousRxSSBdata-DiffSCS&diffTypeD”, or by both the parameter “simultaneousReceptionDiffTypeD_mixSSBandPDSCH” and the parameter “ltaneousRxDataSSB-DiffNumerology” together, which is not limited herein.

Optionally, the terminal device may determine whether to eliminate the scheduling availability also according to the maximum number of Rx beams configured by the terminal device. Illustratively, the terminal device needs to receive N PDCCH/PDSCH associated with different QCL type D at the time-domain unit that conflicts with the reference signal. If N is less than the maximum number of Rx beams configured by the terminal device, remaining Rx beams may be used for measurement, and no scheduling availability is required in this case. If N is greater than or equal to the maximum number of Rx beams configured by the terminal device, the scheduling availability is required.

In another embodiment of the disclosure, the capability in the related art may not be expanded and enhanced, and the terminal device and/or the network device may multiplex the capability parameters in the related art. For example, the first capability is “simultaneousReceptionDiffTypeD”. When the time-domain resources of multiple reference signals overlap, the terminal device may not perform measurement restriction when meeting specific capability requirements. Accordingly, the terminal device needs to perform measurement restriction if the specific capability requirements of the terminal device are not met.

Optionally, in some embodiments, the first scenario is a scenario in which time-domain resources of multiple signals to be received overlap. The operation 210 that the terminal device determines that there is no measurement restriction and/or scheduling availability in the first scenario when the terminal device has the first capability may be implemented by the following methods.

In case that the terminal device has the first capability, the terminal device determines that there is no measurement restriction in the first scenario, if the terminal device meets a first condition. The first condition includes at least one of following conditions: multiple signals to be received are associated with multiple pieces of QCL information of QCL type D; multiple signals to be received are respectively associated with multiple different reception beams; or multiple signals to be received are processed by multiple different baseband processing units.

It should be understood that in the embodiments of the disclosure, the terminal device may simultaneously measure the reference signals using multiple Rx beams, to avoid measurement restriction caused by measurement among multiple reference signals.

Here, multiple signals to be received are associated with multiple different pieces of QCL information of QCL type D, which can be understood as that multiple signals to be received are spatially independent and not correlated with each other. Therefore, the terminal device may receive signals and perform measurement on repeated time-domain resources using independent reception beams in different directions. That is, no measurement restriction may be applied to the terminal device meeting the condition.

The terminal device may receive signals and perform measurement on repeated time-domain resources using independent reception beams in different directions when multiple signals to be received are respectively associated with multiple different reception beams. That is, no measurement restriction may be applied to the terminal device meeting the condition.

In addition, multiple signals to be received are processed by multiple different baseband processing units, that is, the terminal device has an enhanced baseband processing capability and can simultaneously and independently process different signals. Therefore, the terminal device may receive signals and perform measurement processing on repeated time-domain resources using independent reception beams in different directions. That is, no measurement restriction may be applied to the terminal device meeting the condition.

It should be understood that any one of the first conditions described above is met, or any two are met, or all three are met, and it can be determined that there is no measurement restriction.

Optionally, the frequency-domain resources of multiple signals to be received belong to the same carrier or different carriers in the same band.

Alternatively, the frequency-domain resources of multiple signals to be received are located in different bands, and the terminal device does not have the independent beam management capability.

Alternatively, the frequency-domain resources of multiple signals to be received may belong to a high frequency, for example, an FR2 frequency-domain interval.

It should be understood that, in case that the frequency-domain resources of the multiple signals to be received belong to the same carrier or different carriers of the same band, or in case that the frequency-domain resources of multiple signals to be received are located in different FR2 bands and the terminal device does not have an IBM capability, the terminal device determines that there is no measurement restriction in the first scenario if multiple signals to be received are associated with multiple different pieces of QCL information of QCL type D indicating a spatial relationship, and/or multiple signals to be received are respectively associated with multiple different reception beams, and/or multiple signals to be received are processed by multiple different baseband processing units.

Optionally, in addition to determining whether to eliminate measurement restriction based on the above conditions, the terminal device needs to further determine the SCSs of the multiple signals to be received. The operation that terminal device determines that there is no measurement restriction in the first scenario if the terminal device meets the first condition may be further implemented by the following methods.

If the terminal device meets the first condition and a second condition, the terminal device determines that there is no measurement restriction in the first scenario. The second condition may include following condition. Multiple signals to be received have the same sub-carrier spacing, or multiple signals to be received have different sub-carrier spacings and the terminal device has a capability of simultaneously processing signals having different sub-carrier spacings.

It can be understood that, when multiple signals to be received have the same sub-carrier spacing, the terminal device may simultaneously process multiple signals having the same SCS, and no measurement restriction is applied to the terminal device in this case. When multiple signals to be received have different sub-carrier spacings, the terminal device determines that there is no measurement restriction only when the terminal device has the capability of simultaneously processing signals having different sub-carrier spacings. Otherwise, measurement restriction is applied to the terminal device.

Optionally, if the terminal device does not meet any one of the first condition and the second condition, the terminal device performs a measurement based on any one of multiple signals to be received.

It should be understood that in addition to the condition that the terminal device has the first capability “simultaneousReceptionDiffTypeD”, the measurement restriction cannot be eliminated if the terminal device does not meet the specific capability requirements. That is, once multiple signals conflict in the time-domain, only one measurement can be performed among the multiple signals.

In a possible example, the multiple signals to be received may include one SSB and one CSI-RS. The time-domain resources of the SSB for the RLM/BFD/CBD/L1-RSRP/L1-SINR measurement and the CSI-RS for the RLM/BFD/CBD/L1-RSRP/L1-SINR measurement are in the same time-domain unit. In the example, whether to eliminate measurement restriction may be determined through two methods.

In a first method, the frequency-domain resources of the SSB and the CSI-RS belong to the same carrier or different carriers in the same band in the FR2 frequency-domain interval.

In the method, there is no measurement restriction for the SSB for RLM/BFD/CBD/L1-RSRP/L1-SINR measurement and the CSI-RS for RLM/BFD/CBD/L1-RSRP/L1-SINR measurement, if the terminal device supports receiving the SSB and the CSI-RS simultaneously through multiple reception beams (i.e. multi Rx with different QCL type D RSs, That is, the terminal device has the first capability “simultaneousReceptionDiffTypeD”), and the SSB is associated with TCI state 1, and the CSI-RS is associated with TCI state 2. TCI state 1 and TCI state 2 are different. Otherwise, the terminal device needs to measure either the SSB or the CSI-RS instead of both.

Here, the above TCI state 1 may be baseband processing unit 1, and TCI state 2 may be baseband processing unit 2. The baseband processing unit 1 and the baseband processing unit 2 are different and independent of each other. The above TCI state 1 may further be Rx beam 1, and TCI state 2 may further be Rx beam 2. Rx beam 1 and Rx beam 2 are reception beams in different directions.

In addition, the terminal device may further determine the SCSs of the SSB and the CSI-RS. Specifically, if the terminal device supports simultaneously receiving the SSB and the CSI-RS through multiple reception beams, and the SSB is associated with the TCI state 1/baseband processing unit 1, and the CSI-RS is associated with the TCI state 2/baseband processing unit 2, the terminal device determines that there is no measurement restriction on measuring the SSB and the CSI-RS if the SCSs of the SSB and the CSI-RS are the same. If the SCSs of the SSB and the CSI-RS are different, the terminal device determines that there is no measurement restriction on measuring the SSB and the CSI-RS in case that the terminal device has a capability (i.e., the capability indicated by the parameter “simultaneousRxDataSSB-DiffNumerology”) of processing different SCSs. Accordingly, the terminal device needs to measure either the SSB or the CSI-RS instead of both in case that the terminal device does not have the capability indicated by the parameter “simultaneousRxDataSSB-DiffNumerology”.

It should be noted that, if the SSB and the CSI-RS are respectively associated with two independent baseband processing units, that is, the terminal device may process two signals simultaneously, the terminal device may not determine the SCSs of the SSB and the CSI-RS in the process of determining whether to eliminate measurement restriction, and directly eliminate measurement restriction of the SSB and the CSI-RS after determining that the SSBs and the CSI-RS are respectively associated with the two independent baseband processing units.

In a second method, the frequency-domain resources of the SSB and the CSI-RS belong to different bands in the FR2 frequency-domain interval, and the terminal device does not indicate the IBM on the two bands.

Similar to the first method, in the second method, there is no measurement restriction for the SSB for RLM/BFD/CBD/L1-RSRP/L1-SINR measurement and the CSI-RS for RLM/BFD/CBD/L1-RSRP/L1-SINR measurement if the terminal device supports simultaneously receiving the SSB and the CSI-RS through multiple reception beams, and the SSB is associated with TCI state 1, and the CSI-RS is associated with TCI state 2. TCI state 1 and TCI state 2 are different. Otherwise, the terminal device needs to measure either the SSB or the CSI-RS instead of both.

Here, the above TCI state 1 may be baseband processing unit 1, and TCI state 2 may be baseband processing unit 2. The baseband processing unit 1 and the baseband processing unit 2 are different and independent of each other. The above TCI state 1 may further be Rx beam 1, and TCI state 2 may further be Rx beam 2, herein Rx beam 1 and Rx beam 2 are reception beams in different directions.

In addition, the terminal device can further determine the SCSs of the SSB and the CSI-RS, and the determination manner is similar to that of the first method, which will not be repeated here for the sake of brevity.

In another possible example, multiple signals to be received may include a first CSI-RS and a second CSI-RS. The time-domain resources of the first CSI-RS for the RLM/BFD/CBD/L1-RSRP/L1-SINR measurement and the second CSI-RS for the RLM/BFD/CBD/L1-RSRP/L1-SINR measurement are in the same time-domain unit. In this case, if the terminal device supports simultaneously receiving the first CSI-RS and the second CSI-RS through multiple reception beams, and the first CSI-RS is associated with TCI state 1 and the second CSI-RS is associated with TCI state 2 (TCI state 1 and TCI state 2 are different), there is no measurement restriction for the first CSI-RS and the second CSI-RS in the following scenarios. A resource of the first CSI-RS or the second CSI-RS is configured as a repetitive resource; the first CSI-RS and/or the second CSI-RS is configured in a beam detection numerology (e.g., q1), and a beam failure of the first CSI-RS and/or the second CSI-RS is detected; a type of QCL information associated with the first CSI-RS and the second CSI-RS is not the QCL type D, or the QCL information of the first CSI-RS and the second CSI-RS is unknown information.

Here, the above TCI state 1 may be baseband processing unit 1, and TCI state 2 may be baseband processing unit 2. The baseband processing unit 1 and the baseband processing unit 2 are different and independent of each other. The above TCI state 1 may further be Rx beam 1, and TCI state 2 may further be Rx beam 2, and Rx beam 1 and Rx beam 2 are reception beams in different directions.

The scheduling availability scenario is described in detail below.

Optionally, in another embodiment, the first scenario is a scenario in which time-domain resources of at least one channel and at least one signal to be received overlap, and accordingly, the operation 210 that the terminal device determines that there is no measurement restriction and/or scheduling availability in the first scenario includes the following operations.

In case that the terminal device has the first capability, the terminal device determines that there is no scheduling availability in the first scenario if the terminal device meets a third condition. The third condition includes at least one of following conditions. The at least one channel to be received and the at least one signal to be received is respectively associated with multiple pieces of QCL information of the QCL type D, and the number of the at least one channel to be received is less than the number of the multiple reception beams; or the terminal device has a capability of simultaneously processing at least one signal and at least one channel having different sub-carrier spacings.

It should be understood that in the embodiment of the disclosure, the terminal device may simultaneously measure the reference signal and receive downlink channel (e.g., PDCCH and PDSCH) by using multiple Rx beams, so as to avoid scheduling availability on data reception caused by measurement.

Specifically, the terminal device may separately perform measurement and reception of downlink channels/signals based on reception capabilities of the multiple Rx beam, and determine whether to perform scheduling availability for downlink channels/signals on a specific time-domain unit affected by the measurement.

Optionally, whether to impose scheduling availability on the downlink channels/signals can be determined based on the number of resources such as the PDCCH/PDSCH/CSI-RS/TRS that conflict with the reference signal, as well as a relationship between the QCL type D of the resources. Assuming that the terminal device needs to receive N PDCCHs/PDSCHs associated with different QCL types D at the time-domain unit in which the PDCCHs/PDSCHs conflict with the reference signal. If N is less than the number of Rx beams configured by the terminal device, the remaining Rx beams can be used for measurement, and no scheduling availability is impose in this case. If N is greater than or equal to the number of Rx beams configured by the terminal device, the scheduling availability is required.

Optionally, whether to apply scheduling availability on downlink channels/signals is not only related to the capability of the terminal device for simultaneously receiving downlink channels/signals through multiple Rx beams but also to the capability (e.g., the capability indicated by the parameter “simultaneousRxDataSSB-DiffNumerology”) of the terminal device for processing downlink channels/signals having different SCSs. In case that the terminal device has the capability of simultaneously receiving at least one channel and at least one signal and can also receive at least one channel and one signal having different SCSs, there is no scheduling restriction on downlink data reception. Otherwise, scheduling restriction is required.

Optionally, frequency-domain resources of the at least one channel and the at least one signal are located in the same band, and the at least one channel and the at least signal have different sub-carrier spacings.

Alternatively, the frequency-domain resources of the at least one channel and the at least one signal are located in different bands, and the terminal device does not have an independent beam management capability.

Alternatively, the above band may be a high frequency band, for example, an FR2 band interval.

It should be understood that in case that the frequency-domain resources of the at least one channel and the at least one signal to be received are in the same band, or in case that the frequency-domain resources of the at least one channel and the at least one signal to be received are in different FR2 bands and the terminal device does not have the IBM capability, the terminal device may perform scheduling availability if the at least one channel and the at least one signal to be received are respectively associated with multiple pieces of QCL information of the QCL type D, and the number of the at least one channel to be received is less than the number of multiple reception beams, and/or if the terminal device has the capability of simultaneously processing the at least one reference signal and at least one channel having different sub-carrier spacings.

Optionally, in case that the terminal device has the first capability, the terminal device determines not to receive or transmit on a first time-domain unit, and at least one time-domain unit before the first time-domain unit and/or after the first time-domain unit if the terminal device does not meet the third condition. The first time-domain unit is a time-domain unit in which the time-domain resources of the at least one signal and the at least one channel overlap.

Here, the time-domain unit may be a counting unit in the time-domain, and the time-domain unit may be a time-domain symbol (e.g., an OFDM symbol) or a combination of time-domain symbols, and the like, which is limited by the embodiments of the disclosure.

It can be understood that there is no the scheduling restriction when the terminal device meets the third condition, otherwise, there is the scheduling restriction. The terminal device cannot receive or transmit the channel on a conflicting time-domain unit, K time-domain units before the conflicting time-domain unit, and K time-domain units after the conflicting time-domain unit. K is an integer greater than or equal to 1.

It should be noted that the specific time-domain unit affected by the measurement herein can be determined based on the actual situation. For example, in a same-frequency measurement process, if the RSRP or the SINR are measured, the scheduling availability is required on time-domain symbols, in which the SSB is located, and one time-domain symbol before the time-domain symbols and one time-domain symbol after the time-domain symbols. If the RSRQ is measured, scheduling availability is required on time-domain symbols in which the SSB and RSSI measurements are located, on one time-domain symbol before the time-domain symbols, and on one time-domain symbol after the time-domain symbols.

Illustratively, when the terminal device has the capability of simultaneously receiving channels and signals using two Rx beams (i.e., Nsim_Rx_beam=2), the terminal device may simultaneously perform measurement and receive downlink channel/reference signal (PDCCH/PDSCH/TRS/CSI-RS, etc.) using multiple Rx beams in different directions.

For scheduling availability for L1 measurement, whether the resources of the reference signal are the same as the TCI state of the currently active PDCCH/PDSCH TCI or not, there is no need for downlink reception scheduling availability. or the terminal device is restricted from receiving PDCCH/PDSCH associated with two different QCL Type D, but still allowed to receive the PDCCH/PDSCH associated with the same QCL Type D or other QCL types.

The scheduling availability for L3 measurement outside the MG or within the NCSG in L3 may include: in case that the reference signal and channel to be received by the terminal device have different SCSs for one band of FR2, the terminal device determines that there is no measurement restriction if the terminal device has the capability indicated by parameters “simultaneousRx-DiffNumerology” and “simultaneousReceptionDiffTypeD”, and the terminal device determines that the reception or transmission of the channel cannot be performed on a conflicting time-domain unit, K time-domain units before the conflicting time-domain unit and after the conflicting time-domain unit if the terminal device does not have the capability indicated by the parameters “simultaneousRx-DiffNumerology” and “simultaneousReceptionDiffTypeD”.

Further, if the terminal device does not has the IBM capability but has the capability indicated by the parameter “imultaneousReceptionDiffTypeD” on these bands in a band combination of FR2, and the SSB and CSI-RS/data have the same SCS, the terminal device may determine that there is no scheduling availability. Further, when the SSB and the CSI-RS/data have different SCSs, the terminal device may determine there is no scheduling availability if the terminal device has the capability indicated by the parameter “simultaneousRx-DiffNumerology”. Otherwise, the terminal device determines that there is no scheduling availability if the terminal device has IBM capability on these bands.

To sum up, when measurement is performed at a high frequency such as the FR2 band, it is necessary to traverse all Rx beam directions to obtain the final measurement result. When the terminal device has the capability of simultaneously using multiple Rx beams, the measurement restriction and/or scheduling availability can be eliminated by using the capability in the present solution, thereby reducing measurement time and transmission time to a certain extent and improving efficiency.

In addition, the embodiments of the disclosure further provide measurement restriction and scheduling availability for downlink channels/signals when performing measurement which are required to meet in case that the terminal device can perform measurement and/or channel reception on multiple Rx beams. Furthermore, the methods for capability reporting and network configuration of the terminal device are also provided in the embodiments of the disclosure, to provide corresponding operations for different terminal device, thereby meeting the terminal production and certification required by capabilities of different terminal devices.

The preferred embodiments of the disclosure have been described in detail with reference to the drawings, but the disclosure is not limited to the specific details in the above embodiments. Various simple modifications can be made to the technical solutions of the disclosure within the scope of the technical conception of the disclosure, and the simple modifications all fall within the scope of protection of the disclosure. For example, the specific technical features described in the above specific embodiments may be combined in any suitable manner without conflicting with each other, and various possible combinations are not further described in the disclosure in order to avoid unnecessary repetition. For another example, different embodiments of the disclosure can be combined arbitrarily, and the combined embodiments should also be regarded as the contents disclosed in the disclosure as long as they do not violate the idea of the disclosure. For another example, the embodiments and/or features in the embodiments described in the disclosure may be arbitrarily combined with the related art without conflict, and the solutions obtained through any combination should fall within the scope of protection of the disclosure.

It should be understood that the serial numbers of the foregoing processes/operations do not mean an execution sequence in various method embodiments of the disclosure. The execution sequence of the processes should be determined according to functions and internal logics of the processes, and should not be construed as any limitation to the implementation processes of the embodiments of disclosure. In addition, in the embodiments of the disclosure, the terms “downlink”, “uplink” and “sidelink” indicate a transmission direction of the signal or data. The term “downlink” indicates that the transmission direction of the signal or data is a first direction from a station to UE in a cell, the term “uplink” indicates that the transmission direction of the signal or data is a second direction from the UE in the cell to the station, and the term “sidelink” indicates that the transmission direction of the signal or data is a third direction from a first user equipment to a second user equipment. For example, a “downlink signal” means that the transmission direction of the signal is the first direction. In addition, in the embodiments of the disclosure, the term “and/or” is only an association relationship describing associated objects and represents that there are three relationships. Specifically, A and/or B may represent three situations: independent existence of A, existence of both A and B and independent existence of B. In addition, the character “/” used herein usually represents that the associated objects before and after the character form an “or” relationship.

FIG. 8 is a first schematic structural diagram of a wireless communication device according to an embodiment of the disclosure. The wireless communication device is applied to a terminal device, and as illustrated in FIG. 8 includes a first determination unit 801.

The first determination unit 801 is configured to determine, in case that the terminal device has a first capability, that there is no measurement restriction and/or scheduling availability in a first scenario. The first capability at least indicates that the terminal device is capable of simultaneously receiving multiple channels and/or signals on multiple reception beams, and the first scenario is a scenario in which time-domain resources of the multiple channels and/or signals to be received by the terminal device overlap.

Optionally, the first capability the first capability includes at least one of: a capability of simultaneously receiving multiple reference signals of different types on the multiple reception beams; a capability of simultaneously receiving multiple reference signals for different purposes on the multiple reception beams; a capability of simultaneously receiving multiple reference signals having different configurations on the multiple reception beams; a capability of simultaneously receiving at least one reference signal and at least one channel on the multiple reception beams; a capability of processing the multiple signals respectively through multiple baseband processing chains; or a capability of receiving the multiple channels and/or signals respectively through multiple radio frequency circuits.

Optionally, the first determining unit 801 is further configured to determine that there is no measurement restriction in the first scenario in case that the first capability includes at least one of: a capability of simultaneously receiving multiple reference signals of different types on the multiple reception beams; a capability of simultaneously receiving multiple reference signals for different purposes on the multiple reception beams; a capability of simultaneously receiving multiple reference signals having different configurations on the multiple reception beams; a capability of processing the multiple signals respectively through multiple baseband processing units; or a capability of receiving the multiple channels and/or signals respectively through multiple radio frequency chains.

Optionally, the first determining unit 801 is further configured to determine that there is no scheduling availability in the first scenario in case that the first capability includes at least one of: a capability of simultaneously receiving multiple reference signals of different types on the multiple reception beams; or a capability of simultaneously receiving at least one reference signal and at least one channel on the multiple reception beams.

Optionally, the multiple reference signals of different types include at least two of an SSB, a CSI-RS or a PRS.

Optionally, the multiple reference signals for the different purposes includes at least two of an SSB for RLM, an SSB for CBD, an SSB for BFD, an SSB for L1-RSRP measurement, an SSB for L1-SINR measurement, an SSB for L3 measurement, a CSI-RS for the RLM, a CSI-RS for the CBD, a CSI-RS for the BFD, a CSI-RS for the L1-RSRP measurement, a CSI-RS for the L1-SINR measurement, a CSI-RS for CQI, a CSI-RS for the L3 measurement, a PRS for RSRP measurement, a PRS for RSTD measurement; or a PRS for measurement for a time difference between reception and transmission of the terminal device.

Optionally, the configuration of the reference signal includes at least one of an SCS, an RB, a bandwidth or a resource type.

Optionally, the at least one channel includes a PDSCH and/or a PDSCH.

Optionally, the first scenario is the scenario in which the time-domain resources of the multiple signals to be received overlap, the first determining unit 801 is further configured to, in case that the terminal device has the first capability, determine that there is no measurement restriction in the first scenario if the terminal device meets a first condition. The first condition includes at least one of following conditions. The multiple signals to be received are associated with multiple pieces of QCL information of QCL type D; the multiple signals to be received are respectively associated with multiple different reception beams; or the multiple signals to be received are processed by multiple different baseband processing units.

Optionally, frequency-domain resources of the multiple signals to be received belong to the same carrier or different carriers in the same band.

Alternatively, the frequency-domain resources of the multiple signals to be received are located in different FR2 bands, and the terminal device does not have an independent beam management capability.

Optionally, the first determining unit 801 is further configured to determine, if the terminal device meets the first condition and a second condition, that there is no measurement restriction in the first scenario. The second condition includes following condition: the multiple signals to be received have the same sub-carrier spacing; or the multiple signals to be received have different sub-carrier spacings, and the terminal device has a capability of simultaneously processing signals having different sub-carrier spacings.

Optionally, the multiple signals to be received include an SSB and a CSI-RS, or the multiple signals to be received include a first CSI-RS and a second CSI-RS.

Optionally, the first determination unit 801 is further configured to determine, in case that the multiple signals to be received includes a first CSI-RS and a second CSI-RS, that there is no measurement restriction in any of the following sub-scenarios in the first scenario if the terminal device meets the first condition and the second condition. A resource of the first CSI-RS or the second CSI-RS is configured as a repetitive resource; the first CSI-RS and/or the second CSI-RS is configured in a beam detection numerology, and a beam failure of the first CSI-RS and/or the second CSI-RS is detected; or a type of QCL information associated with the first CSI-RS and the second CSI-RS is not the type D, or the QCL information of the first CSI-RS and the second CSI-RS is unknown information.

Optionally, the first determination unit 801 is further configured to perform measurement based on any one of the multiple signals to be received if the terminal device does not meet any one of the first condition and a second condition.

Optionally, the first determining unit 801 is further configured to determine, in case that the terminal device has the first capability, that there is no scheduling availability in the first scenario if the terminal device meets a third condition. The third condition includes at least one of following conditions. The at least one channel to be received and the at least one signal to be received are respectively associated with multiple pieces of QCL information of QCL type D, and the number of the at least one channel to be received is less than the number of the multiple reception beams; or the terminal device has a capability of simultaneously processing at least one reference signal and at least one channel having different sub-carrier spacings.

Optionally, frequency-domain resources of the at least one channel and the at least one signal are located in the same FR2 band, and the at least one channel and the at least signal have different sub-carrier spacings.

Alternatively, the frequency-domain resource of the at least one channel and the frequency-domain resource of the at least one signal are located in different FR2 bands, and the terminal device does not have an independent beam management capability.

Optionally, the first determining unit 801 is further configured to, in case that the terminal device has the first capability, determine, that not to receive or transmit on a first time-domain unit, and at least one time-domain unit before the first time-domain unit and/or at least one time-domain unit after the first time-domain unit if the terminal device does not meet the third condition. The first time-domain unit is a time-domain unit in which the time-domain resources of the at least one signal and the at least one channel overlap.

Optionally, the wireless communication device further includes a first transmission unit configured to transmit device capability information. The device capability information indicates the first capability.

Optionally, the first transmission unit is configured to transmit first indication information. The first indication information indicates at least one of: the maximum number of the multiple reception beams; the multiple reception beams being capable of simultaneous measurement; the multiple reception beams being capable of simultaneous measurement and channel reception; the number of reception beams being capable of measurement among the multiple reception beams; the number of reception beams being capable of L1 measurement among the multiple reception beams; the number of reception beams being capable of L3 measurement among the multiple reception beams; or the number of reception beams being capable of the channel reception among the multiple reception beams.

Optionally, the number of beams corresponding to the multiple channels and/or signals to be received is less than the maximum number of the multiple reception beams.

Optionally, the wireless communication device further includes a first reception unit configured to receive second indication information sent from a network device. The second indication information indicates a function of each of the multiple reception beams.

Optionally, the object having the first capability includes at least one of the terminal device, a band, or a band combination.

FIG. 9 is a second schematic structural diagram of a wireless communication device according to an embodiment of the disclosure. The wireless communication device is applied to a network device. As illustrated in FIG. 9, the wireless communication apparatus includes a second determination unit 901.

The second determination unit 901 is configured to determine, in case that a terminal device has a first capability, that the terminal device has no measurement restriction and/or scheduling availability in a first scenario. The first capability at least indicates that the terminal device is capable of simultaneously receiving multiple channels and/or signals on multiple reception beams, and the first scenario is a scenario in which time-domain resources of the multiple channels and/or signals to be received by the terminal device overlap.

Optionally, the first capability includes at least one of: a capability of simultaneously receiving multiple reference signals of different types on the multiple reception beams; a capability of simultaneously receiving multiple reference signals for different purposes on the multiple reception beams; a capability of simultaneously receiving multiple reference signals having different configurations on the multiple reception beams; a capability of simultaneously receiving at least one reference signal and at least one channel on the multiple reception beams; a capability of processing the multiple channels and/or signals respectively through multiple baseband processing units; or a capability of receiving the multiple channels and/or signals respectively through multiple radio frequency chains.

Optionally, the second determination unit 901 is further configured to determine that the terminal device has no measurement restriction in the first scenario in case that the first capability includes at least one of: a capability of simultaneously receiving multiple reference signals of different types on the multiple reception beams; a capability of simultaneously receiving multiple reference signals for different purposes on the multiple reception beams; a capability of simultaneously receiving multiple reference signals having different configurations on the multiple reception beams; a capability of processing the multiple channels and/or signals respectively through multiple baseband processing chains; or a capability of receiving the multiple channels and/or signals respectively through multiple radio frequency circuits.

Optionally, the second determination unit 901 is further configured to determine that the terminal device has no scheduling availability in the first scenario in case that the first capability includes at least one of: a capability of simultaneously receiving multiple reference signals of different types on the multiple reception beams; or a capability of simultaneously receiving at least one reference signal and at least one channel on the multiple reception beams.

Optionally, the multiple reference signals of different types include at least two of an SSB, a CSI-RS or a PRS.

Optionally, the multiple reference signals for the different purposes includes at least two of an SSB for RLM, an SSB for CBD, an SSB for BFD, an SSB for L1-RSRP measurement, an SSB for L1-SINR measurement, an SSB for L3 measurement, a CSI-RS for the RLM, a CSI-RS for the CBD, a CSI-RS for the BFD, a CSI-RS for the L1-RSRP measurement, a CSI-RS for the L1-SINR measurement, a CSI-RS for CQI, a CSI-RS for the L3 measurement, a PRS for RSRP measurement, a PRS for RSTD measurement; or a PRS for measurement for a time difference between reception and transmission of the terminal device.

Optionally, the configuration of the reference signal includes at least one of an SCS, an RB, a bandwidth or a resource type.

Optionally, the at least one channel includes a PDSCH and/or a PDSCH.

Optionally, the second determination unit 901 is further configured to, in case that the terminal device has the first capability, determine, that the terminal device has no measurement restriction in the first scenario if the terminal device meets a first condition. The first condition includes at least one of following conditions: the multiple signals to be received are associated with multiple pieces of QCL information of QCL type D; the multiple signals to be received are respectively associated with multiple different reception beams; or the multiple signals to be received are processed by multiple different baseband processing units.

Optionally, frequency-domain resources of the multiple signals to be received belong to the same carrier or different carriers in the same band.

Alternatively, the frequency-domain resources of the multiple signals to be received are located in different FR2 bands, and the terminal device does not have an independent beam management capability.

Optionally, the second determination unit 901 is further configured to determine, if the terminal device meets the first condition and a second condition, that the terminal device has no measurement restriction in the first scene. The second condition includes following condition: the multiple signals to be received have the same sub-carrier spacing; or the multiple signals to be received have different sub-carrier spacings, and the terminal device has a capability of simultaneously processing signals having different sub-carrier spacings.

Optionally, the multiple signals to be received include an SSB and a CSI-RS, or the multiple signals to be received include a first CSI-RS and a second CSI-RS.

Optionally, the second determination unit 901 is further configured to determine, in case that the multiple signals to be received includes a first CSI-RS and a second CSI-RS, that the terminal device has no measurement restriction in any of the following sub-scenarios in the first scenario if the terminal device meets the first condition and the second condition. A resource of the first CSI-RS or the second CSI-RS is configured as a repetitive resource; the first CSI-RS and/or the second CSI-RS is configured in a beam detection numerology, and a beam failure of the first CSI-RS and/or the second CSI-RS is detected; or a type of QCL information associated with the first CSI-RS and the second CSI-RS is not the type D, or the QCL information of the first CSI-RS and the second CSI-RS is unknown information.

Optionally, the second determination unit 901 is further configured to determine that the terminal device performs measurement based on any one of the multiple signals to be received if the terminal device does not meet any one of the first condition and a second condition.

Optionally, the first scenario is a scenario in which time-domain resources of at least one channel and at least one signal to be received by the terminal device overlap, and the second determination unit 901 is further configured to determine, in case that the terminal device has the first capability, that the terminal device has no scheduling availability in the first scenario if the terminal device meets a third condition. The third condition includes at least one of following conditions. The at least one channel to be received and the at least one signal to be received are respectively associated with multiple pieces of QCL information of QCL type D, and the number of the at least one channel to be received is less than the number of the multiple reception beams; or the terminal device has a capability of simultaneously processing at least one reference signal and at least one channel having different sub-carrier spacings.

Optionally, frequency-domain resources of the at least one channel and the at least one signal are located in the same FR2 band, and the at least one channel and the at least signal have different sub-carrier spacings.

Alternatively, the frequency-domain resource of the at least one channel and the frequency-domain resource of the at least one signal are located in different FR2 bands, and the terminal device does not have an independent beam management capability.

Optionally, the second determining unit 901 is further configured to, in case that the terminal device has the first capability, determine that the terminal device does not receive or transmit on a first time-domain unit, and at least one time-domain unit before the first time-domain unit and/or at least one time-domain unit after the first time-domain unit if the terminal device does not meet the third condition. The first time-domain unit is a time-domain unit in which the time-domain resources of the at least one signal and the at least one channel overlap.

Optionally, the wireless communication device further includes a second reception unit configured to receive device capability information sent from the terminal device. The device capability information indicates the first capability.

Optionally, the second reception unit is further configured to receive first indication information sent from the terminal device. The first indication information indicates at least one of the maximum number of the multiple reception beams; the multiple reception beams being capable of simultaneous measurement; the multiple reception beams being capable of simultaneous measurement and channel reception; the number of reception beams capable of measurement among the multiple reception beams; the number of reception beams capable of L1 measurement among the multiple reception beams; the number of reception beams capable of L3 measurement among the multiple reception beams; or the number of reception beams of capable of the channel reception among the multiple reception beams.

Optionally, the number of beams corresponding to the multiple channels and/or signals to be received by the terminal device is less than the maximum number of the multiple reception beams.

Optionally, the wireless communication device further includes a second transmission unit configured to transmit second indication information to the terminal device. The second indication information indicates a function of each of the multiple reception beams.

Optionally, the function of each reception beam is determined by the network device based on the first capability of the terminal device and/or first indication information transmitted by the terminal device.

Optionally, the object having the first capability includes at least one of the terminal device, a band, or a band combination.

It should be understood by those skilled in the art that the descriptions about the wireless communication devices in the embodiments of the disclosure may be understood with reference to the descriptions about the wireless communication methods in the embodiments of the disclosure.

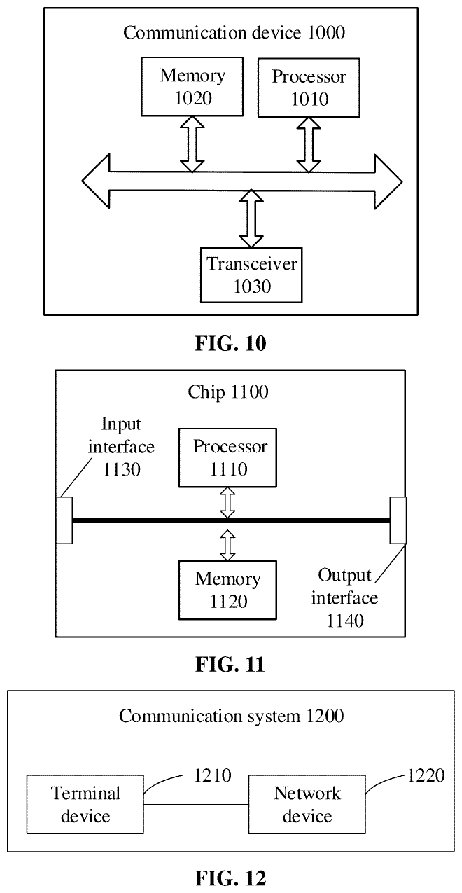

FIG. 10 is a schematic structural diagram of a communication device 1000 according to an embodiment of the disclosure. The communication device may be a terminal device or a network device. The communication device 1000 illustrated in FIG. 10 includes a processor 1010, and the processor 1010 is configured to call a computer program from a memory and run the computer program to implement the method in the embodiments of the disclosure.

Optionally, as illustrated in FIG. 10, the communication device 1000 may further include a memory 1020. The processor 1010 can call the computer program from the memory 1020 and run the computer program to implement the method in the embodiments of the disclosure.

The memory 1020 may be a separate device independent of the processor 1010 or may be integrated into the processor 1010.

Optionally, as illustrated in FIG. 10, the communication device 1000 may further include a transceiver 1030, and the processor 1010 may control the transceiver 1030 to communicate with other devices. Specifically, the transceiver 1030 may send information or data to the other devices or receive information or data from the other devices

The transceiver 1030 may include a transmitter and a receiver. The transceiver 1030 may further include an antenna. The number of the antennas may be one or more.

Optionally, the communication device 1000 may be a network device in the embodiments of the disclosure, and the communication device 1000 can implement corresponding processes implemented by the network device in each method of the embodiments of the disclosure. For simplicity, elaborations are omitted herein.

Optionally, the communication device 1000 may be a mobile terminal/terminal device in the embodiments of the disclosure, and the communication device 1000 can implement corresponding operations implemented by the mobile terminal/terminal device in each method of the embodiments of the disclosure. For simplicity, elaborations are omitted herein.

FIG. 11 is a schematic structural diagram of a chip according to an embodiment of the disclosure. The chip 1100 illustrated in FIG. 11 includes a processor 1110, and the processor 1110 is configured to call a computer program from a memory and run the computer program to implement the methods in the embodiments of the disclosure.

Optionally, as illustrated in FIG. 11, the chip 1100 may further include a memory 1120. The processor 1110 call the computer program from the memory 1120 and run the computer program to implement the methods in the embodiments of the disclosure.

The memory 1120 may be a separate device independent of the processor 1110 or may be integrated into the processor 1110.

Optionally, the chip 1100 may further include an input interface 1130. The processor 1110 may control the input interface 1130 to communicate with other devices or chips. Specifically, the processor may acquire information or data from the other devices or chips through the input interface.

Optionally, the chip 1100 may further include an output interface 1140. The processor 1110 may control the output interface 1140 to communicate with other devices or chips. Specifically, the processor may output information or data to the other devices or chips through the output interface.

Optionally, the chip can be applied to the network device in the embodiment of the disclosure, and the chip can implement corresponding operations implemented by the network device in each method of the embodiments of the disclosure. For simplicity, elaborations are omitted herein.

Optionally, the chip can be applied to the mobile terminal/terminal device in the embodiment of the disclosure, and the chip can implement corresponding operations implemented by the mobile terminal/terminal device in each method of the embodiments of the disclosure. For simplicity, elaborations are omitted herein.

It is to be understood that the chip mentioned in the embodiments of the disclosure may also be called a system-level chip, a system chip, a chip system or a system on chip, or the like.

FIG. 12 is a schematic block diagram of a communication system 1200 according to an embodiment of the disclosure. As illustrated in FIG. 12, the communication system 1200 includes a terminal device 1210 and a network device 1220.

Here, the terminal device 2010 is configured to implement corresponding operations implemented by the terminal device in the above method, and the network device 1220 is configured to implement corresponding operations implemented by the network device in the above method. For simplicity, elaborations are omitted herein.

It should be understood that the processor in the embodiments of the disclosure may be an integrated circuit chip and has a signal processing capability. In an implementation process, each operation in the method embodiments may be completed by an integrated logical circuit in a hardware form in the processor or instructions in a software form. The above processor may be a general purpose processor, a Digital Signal Processor (DSP), an Application Specific Integrated Circuit (ASIC), a Field Programmable Gate Array (FPGA), or other programmable logic devices, a discrete gate or a transistor logical device, or a discrete hardware component, for implementing or executing each method, operation and logical block diagram disclosed in the embodiments of the disclosure. The general purpose processor may be a microprocessor or the processor may also be any conventional processor and the like. The operations in the methods disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM), an Electrically Erasable PROM (EEPROM) and a register. The storage medium is located in a memory, and the processor reads information in the memory, and completes the operations in the above methods in combination with the hardware of the processor.

It can be understood that the memory in the embodiments of the disclosure may be a volatile memory or a non-volatile memory, or may include both the volatile and the non-volatile memories. The non-volatile memory may be a ROM, a PROM, an Erasable PROM (EPROM), an EEPROM or a flash memory. The volatile memory may be a RAM, which is used as an external cache. By way of illustrative but not limiting description, RAMs in various forms may be adopted, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM) and a Direct Rambus RAM (DR RAM). It is to be noted that the memory for the system and method described in the disclosure is intended to include, but not limited to, these and any other suitable types of memories.

It is to be understood that the above description of the memory is exemplary and non-limiting. For example, the memory in the embodiments of the disclosure may also be an SRAM, a DRAM, an SDRAM, a DDR SDRAM, an ESDRAM, an SLDRAM, a DR RAM and the like. That is, the memory in the embodiments of the disclosure is intended to include, but not limited to, these and any other suitable types of memories.

The embodiments of the disclosure further provide a computer-readable storage medium configured to store a computer program.

Optionally, the computer-readable storage medium can be applied to the network device in the embodiments of the disclosure, and the computer program causes a computer to execute corresponding operations implemented by the network device in each method of the embodiment of the disclosure. For simplicity, elaborations are omitted herein.

Optionally, the computer-readable storage medium can be applied to the mobile terminal/terminal device in the embodiments of the disclosure, and the computer program causes a computer to execute corresponding operations implemented by the mobile terminal/terminal device in each method of the embodiment of the disclosure. For simplicity, elaborations are omitted herein.

The embodiments of the disclosure further provide a computer program product including computer program instructions.

Optionally, the computer program product can be applied to the network device in the embodiments of the disclosure, and the computer program instructions cause a computer to execute corresponding operations implemented by the network device in each method of the embodiment of the disclosure. For simplicity, elaborations are omitted herein.

Optionally, the computer program product can be applied to the mobile terminal/terminal device in the embodiments of the disclosure, and the computer program instructions cause a computer to execute corresponding operations implemented by the mobile terminal/terminal device in each method of the embodiment of the disclosure. For simplicity, elaborations are omitted herein.

The embodiments of the disclosure further provide a computer program.

Optionally, the computer program can be applied to the network device in the embodiments of the disclosure, and when the computer program is run on a computer, the computer executes corresponding operations implemented by the network device in each method of the embodiments of the disclosure. For simplicity, elaborations are omitted herein.

Optionally, the computer program can be applied to the mobile terminal/terminal device in the embodiments of the disclosure, and when the computer program is run on the computer, the computer executes corresponding operations implemented by the mobile terminal/terminal device in each method of the embodiments of the disclosure. For simplicity, elaborations are omitted herein.

Those of ordinary skill in the art may realize that the units and algorithm steps of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may implement the described functions for each specific application by use of different methods, but such implementation shall fall within the scope of the disclosure.

Those skilled in the art may clearly learn about that regarding the operation processes of the system, device and unit described above, reference may be made to the corresponding processes in the method embodiments and the operation processes will not be elaborated herein for convenient and brief description.

In some embodiments provided by the disclosure, it is to be understood that the disclosed system, device and method may be implemented in another manner. For example, the device embodiment described above is only schematic, and for example, division of the units is only a logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection through some interfaces, devices or units, and may be electrical, mechanical or in other forms.

The units described as separate parts may or may not be physically separated, and parts displayed as units may or may not be physical units, and namely may be located in the same place, or may also be distributed onto multiple network units. Part or all of the units may be selected to achieve the purpose of the solutions in the embodiments according to a practical requirement.

In addition, functional units in each embodiment of the disclosure may be integrated into a processing unit, each unit may also exist physically and independently, or two or more than two units may also be integrated into a unit.

When being realized in form of software functional unit and sold or used as an independent product, the function may also be stored in a computer-readable storage medium. Based on such an understanding, the substantially part of the technical solutions of the disclosure or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The abovementioned storage medium includes: various media capable of storing program codes such as a U disk, a mobile hard disk, a ROM, a RAM, a magnetic disk or an optical disk.

The foregoing is merely specific embodiments of the disclosure and the scope of protection of the disclosure is not limited thereto. Any variation or replacement easily conceivable by those skilled in the art within the technical scope disclosed by the disclosure shall fall within the scope of protection of the disclosure. Therefore, the scope of protection of the disclosure shall be subject to the scope of protection of the claims.

1. A wireless communication method, comprising:
determining, by a terminal device in case that the terminal device has a first capability, that there is no measurement restriction and/or scheduling availability in a first scenario, wherein the first capability at least indicates that the terminal device is capable of simultaneously receiving a plurality of channels and/or signals on a plurality of reception beams, and the first scenario is a scenario in which time-domain resources of the plurality of channels and/or signals to be received by the terminal device overlap.

2. The method of claim 1, wherein the first capability comprises at least one of:
a capability of simultaneously receiving a plurality of reference signals of different types on the plurality of reception beams;
a capability of simultaneously receiving a plurality of reference signals for different purposes on the plurality of reception beams;
a capability of simultaneously receiving a plurality of reference signals having different configurations on the plurality of reception beams;
a capability of simultaneously receiving at least one reference signal and at least one channel on the plurality of reception beams;
a capability of respectively processing the plurality of signals through a plurality of baseband processing chains; or
a capability of respectively receiving the plurality of channels and/or signals through a plurality of radio frequency circuits.

3. The method of claim 2, wherein the plurality of reference signals of different types comprise at least two of:
a Synchronization Signal/Physical Broadcast Channel Block (SSB), a Channel State Information Reference Signal (CSI-RS), or a Positioning Reference Signal (PRS).

4. The method of claim 2, wherein the plurality of reference signals for the different purposes comprises at least two of:
a Synchronization Signal/Physical Broadcast Channel Block (SSB) for Radio Link Monitoring (RLM);
an SSB for Candidate Beam Detection (CBD);
an SSB for Beam Failure Detection (BFD);
an SSB for Layer 1 (L1)-Reference Signal Received Power (L1-RSRP) measurement;
an SSB for L1-Signal to Interference plus Noise Ratio (L1-SINR) measurement;
an SSB for Layer 3 (L3) measurement;
a Channel State Information Reference Signal (CSI-RS) for the RLM;
a CSI-RS for the CBD;
a CSI-RS for the BFD;
a CSI-RS for the L1-RSRP measurement;
a CSI-RS for the L1-SINR measurement;
a CSI-RS for Channel Quality Indicator (CQI) measurement;
a CSI-RS for the L3 measurement;
a Positioning Reference Signal (PRS) for RSRP measurement;
a PRS for Reference Signal Time Difference (RSTD) measurement; or
a PRS for measurement for a time difference between reception and transmission of the terminal device.

5. The method of claim 2, wherein the configuration of the reference signal comprises at least one of a sub-carrier spacing, a Resource Block (RB), a bandwidth, or a resource type.

6. The method of claim 2, wherein the at least one channel comprises a Physical Downlink Shared Channel (PDSCH) and/or a Physical Downlink Control Channel (PDCCH).

7. The method of claim 1, wherein the first scenario is the scenario in which the time-domain resources of the plurality of signals to be received overlap, and the determining, by the terminal device in case that the terminal device has the first capability, that there is no measurement restriction and/or scheduling availability in the first scenario comprises:
in case that the terminal device has the first capability, determining, by the terminal device if the terminal device meets a first condition, that there is no measurement restriction in the first scenario, wherein the first condition comprises at least one of following conditions:
the plurality of signals to be received are associated with a plurality of pieces of Quasi Co-Location (QCL) information of a QCL type D;
the plurality of signals to be received are respectively associated with a plurality of different reception beams; or
the plurality of signals to be received are processed by a plurality of different baseband processing units.

8. The method of claim 7, wherein
frequency-domain resources of the plurality of signals to be received belong to a same carrier or different carriers in a same band; or
the frequency-domain resources of the plurality of signals to be received are located in different Frequency Range 2 (FR2) bands, and the terminal device does not have an independent beam management capability.

9. The method of claim 7, wherein the determining, by the terminal device, that there is no measurement restriction in the first scenario if the terminal device meets the first condition comprises:
determining, by the terminal device, that there is no measurement restriction in the first scenario if the terminal device meets the first condition and a second condition,
wherein the second condition comprises following condition:
the plurality of signals to be received have a same sub-carrier spacing; or
the plurality of signals to be received have different sub-carrier spacings, and the terminal device has a capability of simultaneously processing signals having different sub-carrier spacings.

10. The method of claim 7, wherein the plurality of signals to be received comprises a Synchronization Signal/Physical Broadcast Channel Block (SSB) and a Channel State Information Reference Signal (CSI-RS), or the plurality of signals to be received comprises a first CSI-RS and a second CSI-RS.

11. The method of claim 9, wherein in case that the plurality of signals to be received comprises a first Channel State Information Reference Signal (CSI-RS) and a second CSI-RS, and the terminal device determines if the terminal device meets the first condition and the second condition that there is no measurement restriction in any of following sub-scenarios in the first scenario:
a resource of the first CSI-RS or the second CSI-RS is configured as a repetitive resource;
the first CSI-RS and/or the second CSI-RS is configured in a beam detection numerology, and a beam failure of the first CSI-RS and/or the second CSI-RS is detected; or
a type of QCL information associated with the first CSI-RS and the second CSI-RS is not the type D, or the QCL information of the first CSI-RS and the second CSI-RS is unknown information.

12. The method of claim 1, wherein the first scenario is a scenario in which time-domain resources of at least one channel and at least one signal to be received overlap, and the determining, by the terminal device in case that the terminal device has the first capability, that there is no measurement restriction and/or scheduling availability in the first scenario comprises:
in case that the terminal device has the first capability, determining, by the terminal device if the terminal device meets a third condition, that there is no scheduling availability in the first scenario, wherein the third condition comprises at least one of following conditions:
the at least one channel to be received and the at least one signal to be received are respectively associated with a plurality of pieces of Quasi Co-Location (QCL) information of QCL type D, and a number of the at least one channel to be received is less than a number of the plurality of reception beams; or
the terminal device has a capability of simultaneously processing at least one reference signal and at least one channel having different sub-carrier spacings.

13. The method of claim 12, further comprising:
in case that the terminal device has the first capability, determining, by the terminal device if the terminal device does not meet the third condition, not to receive or transmit on a first time-domain unit, and at least one time-domain unit before the first time-domain unit and/or at least one time-domain unit after the first time-domain unit, wherein the first time-domain unit is a time-domain unit in which the time-domain resources of the at least one signal and the at least one channel overlap.

14. That method of claim 1, further comprising:
transmitting, by the terminal device, device capability information, the device capability information indicating the first capability.

15. The method of claim 1, further comprising:
transmitting, by the terminal device, first indication information, the first indication information indicating at least one of:
a maximum number of the plurality of reception beams;
the plurality of reception beams being capable of simultaneous measurement;
the plurality of reception beams being capable of simultaneous measurement and channel reception;
a number of reception beams capable of measurement among the plurality of reception beams;
a number of reception beams capable of Layer 1 (L1) measurement among the plurality of reception beams;
a number of reception beams capable of Layer 3 (L3) measurement among the plurality of reception beams; or
a number of reception beams capable of the channel reception among the plurality of reception beams.

16. The method of claim 1, wherein at least one of the terminal device, a band, or a band combination has the first capability.

17. A wireless communication method, comprising:
determining, by a network device in case that a terminal device has a first capability, that the terminal device has no measurement restriction and/or scheduling availability in a first scenario, wherein the first capability at least indicates that the terminal device is capable of simultaneously receiving a plurality of channels and/or signals on a plurality of reception beams, and the first scenario is a scenario in which time-domain resources of the plurality of channels and/or signals to be received by the terminal device overlap.

18. A terminal device comprising: a memory, a processor and a transceiver, wherein the transceiver is configured to communicate with a network device, the memory is configured to store a computer program executable on the processor, and the processor, when executing the program in conjunction with the transceiver, is configured to:
determine, in case that the terminal device has a first capability, that there is no measurement restriction and/or scheduling availability in a first scenario, wherein the first capability at least indicates that the terminal device is capable of simultaneously receiving a plurality of channels and/or signals on a plurality of reception beams, and the first scenario is a scenario in which time-domain resources of the plurality of channels and/or signals to be received by the terminal device overlap.

19. The terminal device of claim 18, wherein the first capability comprises at least one of:
a capability of simultaneously receiving a plurality of reference signals of different types on the plurality of reception beams;
a capability of simultaneously receiving a plurality of reference signals for different purposes on the plurality of reception beams;
a capability of simultaneously receiving a plurality of reference signals having different configurations on the plurality of reception beams;
a capability of simultaneously receiving at least one reference signal and at least one channel on the plurality of reception beams;
a capability of respectively processing the plurality of signals through a plurality of baseband processing chains; or
a capability of respectively receiving the plurality of channels and/or signals through a plurality of radio frequency circuits.

20. The terminal device of claim 19, wherein the plurality of reference signals of different types comprise at least two of:
a Synchronization Signal/Physical Broadcast Channel Block (SSB), a Channel State Information Reference Signal (CSI-RS), or a Positioning Reference Signal (PRS).
